(19) United States
(12) Patent Application Publication
(10) Pub. No.: US 2017/0186097 A1
(43) Pub. Date: Jun. 29, 2017

(54) METHOD AND SYSTEM FOR USING TEMPORAL DATA AND/OR TEMPORALLY FILTERED DATA IN A SOFTWARE SYSTEM TO OPTIMIZE, IMPROVE, AND/OR MODIFY GENERATION OF PERSONALIZED USER EXPERIENCES FOR USERS OF A TAX RETURN PREPARATION SYSTEM

(71) Applicant: Intuit Inc., Mountain View, CA (US)

(72) Inventors: Massimo Mascaro, San Diego, CA (US); Joseph Cessna, San Diego, CA (US); Peter Ouyang, San Diego, CA (US)

(73) Assignee: Intuit Inc., Mountain View, CA (US)

(21) Appl. No.: 14/981,129

(22) Filed: Dec. 28, 2015

(51) Int. Cl. G06Q 40/00; G06F 17/30

(52) U.S. Cl. CPC G06Q 40/123; G06F 17/30867; G06F 17/30551; G06F 17/30528

(57) ABSTRACT

A method and system adaptively improves potential customer conversion rates, revenue metrics, and/or other target metrics by providing effective user experience options, from a variety of different user experience options, to some users while concurrently testing user responses to other user experience options, according to one embodiment. The method and system selects the user experience options by applying user characteristics data to an analytics model, according to one embodiment. The user characteristics data include time data, e.g., when a user interacts with a software system, according to one embodiment. The method and system applies one or more time filters to data samples to train the analytics model, and the method and system analyzes user responses to the user experience options to update the analytics model, and to dynamically adapt the personalization of the user experience options, at least partially based on feedback from users, according to one embodiment.

### BACKGROUND

Federal and State Tax law has become so complex that it is now estimated that each year Americans alone use over 6 billion person hours, and spend nearly 4 billion dollars, in an effort to comply with Federal and State Tax statutes. Given this level of complexity and cost, it is not surprising that more and more taxpayers find it beneficial to obtain help, in one form or another, to prepare their taxes. Tax return preparation systems, such as tax return preparation software programs and applications, represent a potentially flexible, highly accessible, and affordable source of tax preparation assistance. However, traditional tax return preparation systems are, by design, fairly generic in nature and often lack the malleability to meet the specific needs of a given user.

For instance, traditional tax return preparation systems often present a fixed, e.g., predetermined and pre-packaged, structure or sequence of questions to all users as part of the tax return preparation interview process. This is largely due to the fact that the traditional tax return preparation system analytics use a sequence of interview questions, and/or other user experiences, that are static features and that are typically hard-coded elements of the tax return preparation system and do not lend themselves to effective or efficient modification. As a result, the user experience, and any analysis associated with the interview process and user experience, is a largely inflexible component of a given version of the tax return preparation system.

As another consequence of employing static features and/or hard-coded elements in a tax return preparation system, the interview processes and/or the user experience of traditional tax return preparation systems can only be modified through a redeployment of the tax return preparation system itself. Therefore, there is little or no opportunity for any analytics associated with the interview process, and/or user experience, to evolve to meet a changing situation or the particular needs of a given taxpayer, even as more information about that taxpayer, and their particular circumstances, is obtained.

Failing to adapt a tax return preparation system to changes in user behaviors and preferences can cause users to have an impersonal and disconnected experience, causing the users to misperceive or incorrectly believe that the tax return preparation systems are unable to accommodate, appreciate, or understand their specific circumstances. However, just as political views of a population can change over time based on external stimuli, such as war, terrorism, new legislation, movies, news articles, social media, and emerging technology, users' personal preferences for user experiences for and/or within tax return preparation systems, financial management system, and other software systems can also evolve. As a result, failing to adapt a tax return preparation system to evolving user preferences can alienate users from products/services that can otherwise be extremely temporally and/or fiscally beneficial to the users.

What is needed is a method and system for applying temporal data and/or temporal settings to analytics models to optimize, improve, and/or modify personalized user experiences provided by software systems, according to various embodiments.

### SUMMARY

Embodiments of the present disclosure address some of the shortcomings associated with traditional tax return preparation systems and other software systems by applying temporal data and/or temporal settings to analytics models to optimize, improve, and/or modify personalized user experiences provided by a software system, according to various embodiments. The software system applies time data (e.g., when a user logs into or interacts with a software system) and other user characteristics to a user experience analytics model to determine and deliver personalized user experiences to current users (of the software system), based on preferences of prior users (of the software system) who are similar to the current users, according to one embodiment. The personalized user experiences include one or more user experience options that are probabilistically likely to be preferred by the recipients (e.g., current users) of the personalized user experiences, according to one embodiment.

To improve the likelihood of providing preferred user experience options to current users, the software system trains the user experience analytics model by time filtering data samples that are used in training the user experience analytics model, according to one embodiment. The data samples include data representing existing user characteristics and data representing existing user actions/responses of prior users of the software system. The software system time filters the data samples by sizing and applying a sliding window and/or a decaying window to the data samples, according to one embodiment. The software system omits data samples that are outside of the sliding window, according to one embodiment. The software system omits data samples that are outside of the decaying window, and the decaying window causes the software system to emphasize (e.g., weight) the influence of newer data samples over older data samples, according to one embodiment.

The software system uses the user experience analytics model to concurrently, dynamically and adaptively validate and test the effects of user experience options amongst groups of current users, as a new technique for A/B testing user experience options. The software system groups prior and current users into segments of users, based on the user characteristics (e.g., age, income, home ownership, time data, etc.) that are common to the segments of users. The user experience analytics model determines likely preferences for current users based on the preferences of prior users, and the software system applies at least two different user experience options to the current users of a segment to validate some users' preference for one of the user experience options and to test other users' preference for the other of the user experience options. By dynamically adapting the frequency with which the two different user experience options are delivered to current users of a particular segment, the software system dynamically adapts and improves the accuracy with which the software system delivers user experience options that are actually or likely to be preferred by the current users of the software system, according to one embodiment. The software system analyzes user responses to the user experience options to update the user experience analytics model and to dynamically adapt the personalization of the user experience options, at least partially based on feedback from users, according to one embodiment. In one embodiment, the software system is a tax return preparation system.

Embodiments of the disclosed software system provides superior testing results over traditional A/B testing, while seamlessly integrating feedback from the A/B testing into the software system. Traditional A/B testing is inefficient. For example, traditional A/B testing allocates control conditions to 50% of a set of users as a control group and allocates experimental conditions to 50% of the set of users as an experimental group, without regard to the likelihood of satisfactory performance of the control conditions over the test conditions or vice versa. The test conditions are typically set, until a critical confidence, e.g., 95% confidence, is reached. By contrast, the disclosed system dynamically allocates and re-allocates control conditions and test conditions concurrently, to enable the software system to both test new user experience options while providing users with personalized user experiences that they are probabilistically likely to prefer. As a result, more users of the software system are likely to be satisfied with the software system and are more likely to complete a predetermined/desired action (e.g., completing questions, visiting a sequence of web pages, file a tax return, etc.) because the users receive relevant and/or preferred user experience options sooner than the same users would with the implementation of traditional A/B testing techniques. The improvements in customer satisfaction and the increases in customers completing predetermined actions in the software system results in increased conversions of potential customers to paying customers, which translates to increased revenue for service providers, according to one embodiment.

By applying temporal data and/or temporal settings to analytics models to optimize, improve, and/or modify personalized user experiences provided by software systems, implementation of embodiments of the present disclosure allows for significant improvement to the fields of user experience, electronic tax return preparation, data analytics, data collection, and data processing, according to one embodiment. As one illustrative example, by adaptively distributing user experience options to users based on temporal user data and/or temporal settings (e.g., time-based filters), embodiments of the present disclosure allows for progressing a user through software system user flows and/or tax return preparation sessions with fewer processing cycles and less communications bandwidth because the user is more likely to be satisfied and less likely to prematurely terminate his/her user session prior to completing a particular activity (e.g., filing a tax return). This reduces processing cycles and communications bandwidth because a satisfied user does not redundantly use processing cycles and bandwidth to reenter his/her information into competing tax return preparation system and/or software system. In other words, improving customer satisfaction, by personalizing the user experiences, reduces global energy consumption by reducing redundant efforts and inefficiencies associated therewith. As a result, embodiments of the present disclosure allow for improved processor performance, more efficient use of memory access and data storage capabilities, reduced communication channel bandwidth utilization, and therefore faster communications connections.

In addition to improving overall computing performance, by applying temporal data and/or temporal settings to analytics models to optimize, improve, and/or modify personalized user experiences provided by software systems, implementation of embodiments of the present disclosure represent a significant improvement to the field of automated user experiences and, in particular, efficient use of human and non-human resources. As one illustrative example, by increasing personal preferences for user experience options and by reducing presentation of non-preferred/less-effective user experience options, the user can more easily comprehend and interact with digital user experience displays and computing environments, reducing the overall time invested by the user to the tax return preparation or other software system-related tasks. Additionally, selectively presenting user experience options to users, based on their user characteristics, improves and/or increases the likelihood that a potential customer will be converted into a paying customer because the potential customer receives confirmation that the software system appears to understand the particular user's needs and preferences, according to one embodiment. Consequently, using embodiments of the present disclosure, the user experience is less burdensome, less time consuming and allows the user to dedicate more of his or her time to other activities or endeavors, while having confidence that the tax return preparation system and/or software system is adequately addressing the needs of the user.

### BRIEF DESCRIPTION OF THE DRAWINGS

FIGS. 1A and 1B are graph diagrams of A/B testing techniques, in accordance with one embodiment.

FIGS. 2A, 2B, 2C, and 2D illustrate example diagrams of some of the temporal characteristics of user interaction with a software system that are defined in and/or applied to a user experience analytics model for determining user preferences for user experience options, in accordance with one embodiment.

FIGS. 3A and 3B illustrate example diagrams of time filtering techniques that are used to guide, shape, define and/or direct at least part of the operation of a user experience analytics model in determining users' preferences for user experience options in a software system, in accordance with one embodiment.

FIG. 4 is a block diagram of an example architecture for using time data and time filters for adaptively providing personalized user experiences, in accordance with one embodiment.

FIG. 5 is a flow diagram of an example of a process for training and updating a user experience analytics model, in accordance with one embodiment.

FIG. 6 is a diagram of an example of a tree diagram for defining at least part of a user experience analytics model, in accordance with one embodiment.

FIG. 7 is a flow diagram of an example of a process for defining a user experience analytics model, in accordance with one embodiment.

FIG. 8 is a flow diagram of an example of a process for determining a stop probability, in accordance with one embodiment.

FIG. 9 is a flow diagram of an example of a process for computing the effective performance of a segment or sub-segment of users, in accordance with one embodiment.

FIG. 10 is a flow diagram of an example of a process for computing the effective performance of input estimates blended by Thompson Sampling, in accordance with one embodiment.

FIGS. 11A and 11B are a flow diagram of an example of a process for applying temporal data and/or temporally filtered data to a software system to provide personalized user experiences to users, in accordance with one embodiment.

Common reference numerals are used throughout the FIGs. and the detailed description to indicate like elements. One skilled in the art will readily recognize that the above FIGs. are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs., which depict one or more exemplary embodiments. Embodiments may be implemented in many different forms and should not be construed as limited to the embodiments set forth herein, shown in the FIGs., and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for applying temporal data and/or temporal settings to analytics models to optimize, improve, and/or modify personalized user experiences provided by software systems, according to various embodiments.

### Introductory System

Herein, a software system can be, but is not limited to, any data management system implemented on a computing system, accessed through one or more servers, accessed through a network, accessed through a cloud, and/or provided through any system or by any means, as discussed herein, and/or as known in the art at the time of filing, and/or as developed after the time of filing, that gathers/obtains data, from one or more sources and/or has the capability to analyze at least part of the data.

As used herein, the term software system includes, but is not limited to the following: computing system implemented, and/or online, and/or web-based, personal and/or business tax preparation systems; computing system implemented, and/or online, and/or web-based, personal and/or business financial management systems, services, packages, programs, modules, or applications; computing system implemented, and/or online, and/or web-based, personal and/or business management systems, services, packages, programs, modules, or applications; computing system implemented, and/or online, and/or web-based, personal and/or business accounting and/or invoicing systems, services, packages, programs, modules, or applications; and various other personal and/or business electronic data management systems, services, packages, programs, modules, or applications, whether known at the time of filling or as developed later.

Specific examples of software systems include, but are not limited to the following: TurboTax™ available from Intuit, Inc. of Mountain View, Calif.; TurboTax Online™ available from Intuit, Inc. of Mountain View, Calif.; QuickBooks™, available from Intuit, Inc. of Mountain View, Calif.; QuickBooks Online™, available from Intuit, Inc. of Mountain View, Calif.; Mint™, available from Intuit, Inc. of Mountain View, Calif.; Mint Online™, available from Intuit, Inc. of Mountain View, Calif.; and/or various other software systems discussed herein, and/or known to those of skill in the art at the time of filing, and/or as developed after the time of filing.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the term “production environment” includes the various components, or assets, used to deploy, implement, access, and use, a given software system as that software system is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement at least part of the software system in the production environment such as a data center, a cloud computing environment, a dedicated hosting environment, and/or one or more other computing environments in which one or more assets used by the application in the production environment are implemented; one or more computing systems or computing entities used to implement at least part of the software system in the production environment; one or more virtual assets used to implement at least part of the software system in the production environment; one or more supervisory or control systems, such as hypervisors, or other monitoring and management systems used to monitor and control assets and/or components of the production environment; one or more communications channels for sending and receiving data used to implement at least part of the software system in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement at least part of the software system in the production environment; one or more databases used to store data in the production environment; one or more internal or external services used to implement at least part of the software system in the production environment; one or more backend systems, such as backend servers or other hardware used to process data and implement at least part of the software system in the production environment; one or more software modules/functions used to implement at least part of the software system in the production environment; and/or any other assets/components making up an actual production environment in which at least part of the software system is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known, “trusted” environments or unknown, “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate at least part of the software system.

In various embodiments, one or more cloud computing environments are used to create, and/or deploy, and/or operate at least part of the software system that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given software system or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets within one or more cloud or traditional computing environments.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user experience display” includes not only data entry and question submission user interfaces, but also other user experience features provided or displayed to the user such as, but not limited to the following: data entry fields; question quality indicators; images; backgrounds; avatars; highlighting mechanisms; icons; and any other features that individually, or in combination, create a user experience, as discussed herein, and/or as known in the art at the time of filing, and/or as developed after the time of filing.

As used herein, the term “user experience” includes not only the user session, interview process, interview process questioning, and/or interview process questioning sequence, but also other user experience features provided or displayed to the user such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing. As used herein, the term “user experience option(s)” include one or more of a variety of user experiences available for presentation, delivery, and/or application to a user or to a user's session with a software system.

Herein, the term “party”, “user”, “user consumer”, “customer”, and “potential customer” are used interchangeably to denote any party and/or entity that interfaces with, and/or to whom information is provided by, the disclosed methods and systems described herein, and/or a person and/or entity that interfaces with, and/or to whom information is provided by, the disclosed methods and systems described herein, and/or a legal guardian of person and/or entity that interfaces with, and/or to whom information is provided by, the disclosed methods and systems described herein, and/or an authorized agent of any party and/or person and/or entity that interfaces with, and/or to whom information is provided by, the disclosed methods and systems described herein. For instance, in various embodiments, a user can be, but is not limited to, a person, a commercial entity, an application, a service, and/or a computing system.

As used herein, the term “analytics model” or “analytical model” denotes one or more individual or combined algorithms or sets of equations that describe, determine, and/or predict characteristics of or the performance of a datum, a data set, multiple data sets, a computing system, and/or multiple computing systems. Analytics models or analytical models represent collections of measured and/or calculated behaviors of attributes, elements, or characteristics of data and/or computing systems.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein, the term “decision tree” denotes a hierarchical tree structure, with a root node, parent nodes, and children nodes. The parent nodes are connected to children nodes through edges, and edge logic between parent nodes and children nodes performs a gating function between parent nodes and children nodes to permit or block the flow of a path from a parent node to a child node. As used herein, a node is associated with a node action that a model or process performs on a data sample, a set of data samples, a current user, or a segment of current users.

As used herein, the term “segment” and “segment of users” denotes a portion, section, or subset of a set of users (i.e., a user set). A segment can include an entire set of users or a portion of a set of users. As used herein a segment or sub-segment denotes a portion, section, or subset of users who have one or more user characteristics (as defined below) in common.

As used herein, the term “distribution frequency rate” denotes decimal numbers, fractions, and/or percentages that represent an average quantity of traffic within a segment of users to which one or more user experience options are provided, with the software system. In alternative language, the term distribution frequency rate denotes decimal numbers, fractions, and/or percentages that represent an average quantity of traffic for a segment of users by which one or more user experience options are provided to a segment of users within a software system. For example, within a single segment of users, a first user experience option A is provided to users with a first distribution frequency rate, a second user experience option B is provided to users with a second distribution frequency rate, and the second distribution frequency rate is 1 minus the first distribution frequency rate, according to one embodiment and as disclosed further below.

### Hardware Architecture

Disclosed herein is a production environment for applying temporal data and/or temporal settings to analytics models to optimize, improve, and/or modify personalized user experiences provided by a software system, according to various embodiments. The software system applies time data (e.g., when a user logs into or interacts with a software system) and other user characteristics to a user experience analytics model to determine and deliver personalized user experiences to current users (of the software system), based on preferences of prior users (of the software system) who are similar to the current users, according to one embodiment. The personalized user experiences include one or more user experience options that are probabilistically likely to be preferred by the recipients (e.g., current users) of the personalized user experiences, according to one embodiment.

To improve the likelihood of providing preferred user experience options to current users, the software system trains the user experience analytics model by time filtering data samples that are used in training the user experience analytics model, according to one embodiment. The data samples include data representing existing user characteristics and data representing existing user actions/responses of prior users of the software system. The software system time filters the data samples by sizing and applying a sliding window and/or a decaying window to the data samples, according to one embodiment. The software system omits data samples that are outside of the sliding window, according to one embodiment. The software system omits data samples that are outside of the decaying window, and the decaying window causes the software system to emphasize (e.g., weight) the influence of newer data samples over older data samples, according to one embodiment.

Embodiments of the disclosed software system provides superior testing results over traditional A/B testing, while seamlessly integrating feedback from the A/B testing into the software system. Traditional A/B testing is inefficient. For example, traditional A/B testing allocates control conditions to 50% of a set of users as a control group and allocates experimental conditions to 50% of the set of users as an experimental group, without regard to the likelihood of satisfactory performance of the control conditions over the test conditions or vice versa. The test conditions are typically set, until a critical confidence, e.g., 95% confidence, is reached. By contrast, the disclosed system dynamically allocates and re-allocates control conditions and test conditions concurrently, to enable the software system to both test new user experience options while providing users with personalized user experiences that they are probabilistically likely to prefer. As a result, more users of the software system are likely to be satisfied with the software system and are more likely to complete a predetermined/desired action (e.g., completing questions, visiting a sequence of web pages, file a tax return, etc.) because the users receive relevant and/or preferred user experience options sooner than the same users would with the implementation of traditional A/B testing techniques. The improvements in customer satisfaction and the increases in customers completing predetermined actions in the software system results in increased conversions of potential customers to paying customers, which translates to increased revenue for service providers, according to one embodiment.

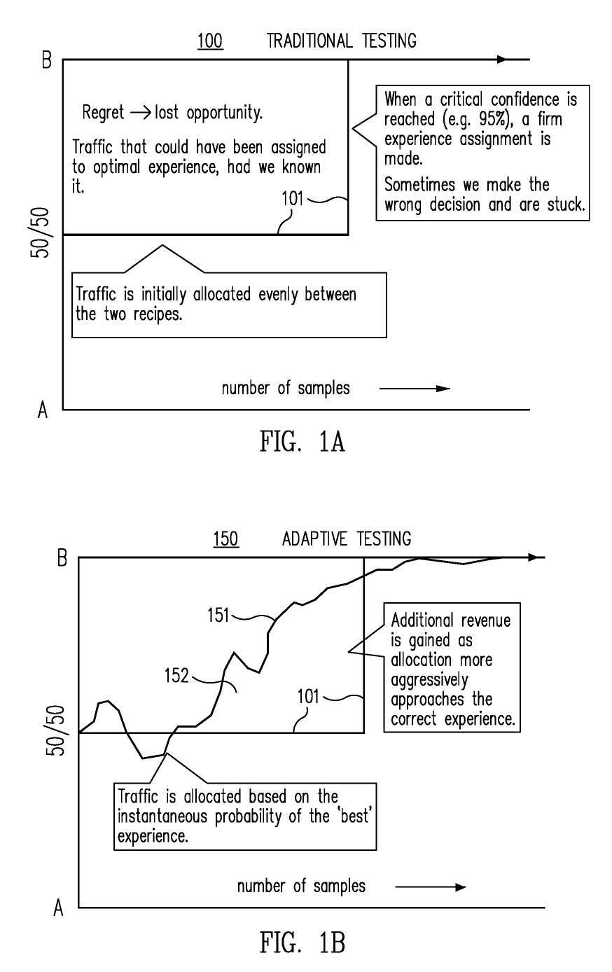

FIGS. 1A and 1B are graphical representations of some of the advantages of adaptive A/B testing over traditional A/B testing, according to one embodiment. FIG. 1A is an example of a graph 100 that illustrates delivery of a condition A to 50% of a user set and delivery of a condition B to 50% of a user set for a number of samples (x-axis), using traditional A/B testing techniques. Conditions A and B are equally distributed to the user sets until a critical confidence level is reached, e.g., 95%. After the critical confidence level is reached, traditional testing techniques switch to delivering the more successful of the conditions to 100% of the user set. In the graph 100, the test switches at a number of samples, represented by graph line 101, that were tested until a confidence level (e.g., 95%) was reached. Everything above and to the left of the graph line 101 represents lost opportunity to provide condition B to the user set rather than condition A (which has ultimately been deemed inferior).

FIG. 1B shows a graph 150 that illustrates an adaptive delivery of condition A (e.g., a first user experience option) and condition B (e.g., a second user experience option) to the user set while determining which condition is superior to the other, according to one embodiment. The graph 150 includes a graph line 151 that represents a percentage of condition B that is allocated to the user set, according to one embodiment. The area 152 that is under the graph line 151 illustrates that more users of the user set receive condition B sooner by using adaptive A/B testing instead of the traditional A/B testing illustrated by FIG. 1A, according to one embodiment. Importantly, providing condition B sooner equates to providing more users with user experiences that are in accordance with the users' preferences and that are more likely to assist users in completing or accomplishing a particular activity (e.g., providing personal information, paying for a service, signing up as a service provider customer, staying logged in to a user session, complete filing a tax return, etc.), according to one embodiment. Thus, implementation of adaptive testing by providing personalized user experiences in a software system, as disclosed herein, translates to increases in quantities of satisfied customers and improved revenue for the service provider of the software system, according to one embodiment. The systems and methods of FIGS. 4-11 disclose various embodiments that leverage the advantages of adaptive testing as described with respect to FIGS. 1A and 1B, according to one embodiment.

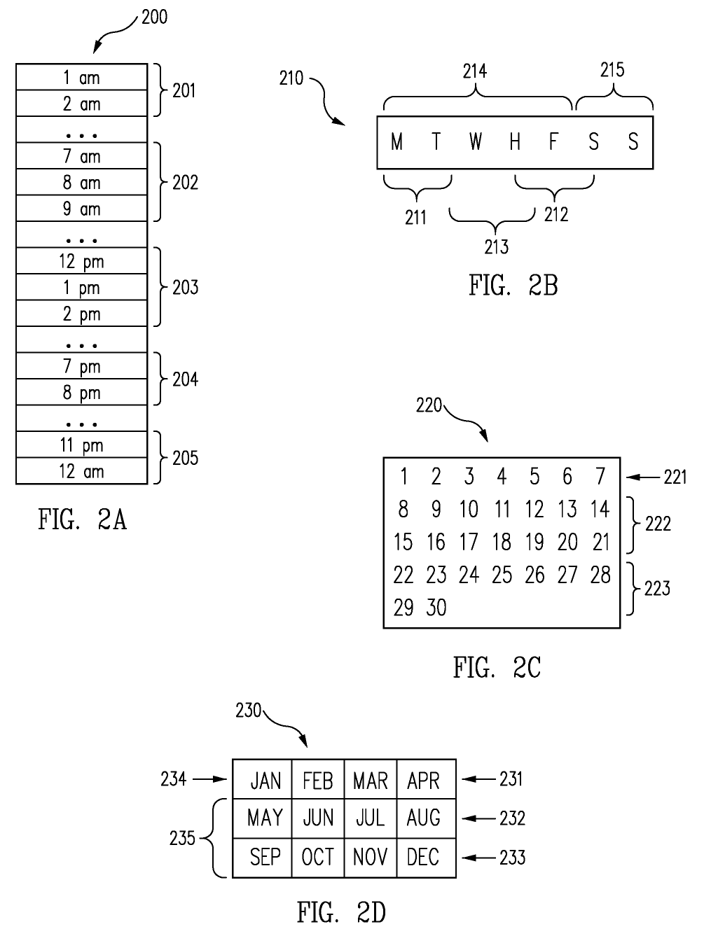

FIGS. 2A-2D illustrate example diagrams of some of the temporal characteristics of user interaction with a software system (e.g., a tax return preparation system) that are defined in and/or applied to a user experience analytics model for determining user preferences for user experience options. The temporal characteristics of user interactions with a software system are referred to herein as time data or temporal data. The time data is part of the user characteristics data received or collected by the software system from or about prior and current users of a software system. The time data and other user characteristics data are used by the user experience analytics model to categorize/group users into segments of users based on similarities in the user characteristics data. The software system determines correlations between segments of users and the users' preferences for receiving user experience options, according to one embodiment. The software system defines at least part of the operations of the user experience analytics model based on correlations between the user characteristics of prior users (i.e., of the software system) and the user experience options preferences of prior users, according to one embodiment. The user experience analytics model then determines likely preferences for user experience options for current users based on similarities between the user characteristics of the current users and the user characteristics of the prior users, according to one embodiment.

FIG. 2A illustrates a time-of-day diagram 200 showing one embodiment of time-based user characteristics data that can be used to define and/or be applied to a user experience analytics model to define and/or determine users' preferences for user experience options. The time-of-day diagram 200 shows examples of time-of-day time data or time-based user characteristics data that include, but are not limited to, early morning hours 201 (e.g., 1 am-5 am), morning hours 202 (e.g., 6 am-10 am), mid-day hours 203 (e.g., 11 am-2 pm), evening hours 204 (e.g., 6 pm-9 pm), and late night hours 205 (e.g., 10 pm-11:59 pm), according to one embodiment. The time of day during which a user views, logs into, files a tax return with, and/or otherwise interacts with a software system (e.g., tax return preparation system) is one of a number of user characteristics used by a user experience analytics model to determine users' preferences for user experience options, according to one embodiment.

FIG. 2B illustrates a day-of-week diagram 210 showing one embodiment of time-based user characteristics data that can be used to define and/or be applied to a user experience analytics model to define and/or determine users' preferences for user experience options. The day-of-week diagram 210 shows examples of day-of-week time data or time-based user characteristics data that include, but are not limited to, beginning of the week 211, end of the week 212, mid-week 213, week days 214, and weekend days 215, according to one embodiment. Other examples of day-of-week time data includes individual days during which users interact with a software system, according to one embodiment. The day of the week during which a user views, logs into, files a tax return with, and/or otherwise interacts with a software system is one of a number of user characteristics used by a user experience analytics model to determine users' preferences for user experience options, according to one embodiment.

FIG. 2C illustrates a time-of-month diagram 220 showing one embodiment of time-based user characteristics data that can be used to define and/or be applied to a user experience analytics model to define and/or determine users' preferences for user experience options. The time-of-month diagram 220 shows examples of time-of-month time data or time-based user characteristics data that include, but are not limited to, beginning of the month 221, middle of the month 222, and end of the month 223, according to one embodiment. Other examples of time-of-month time data includes individual days (e.g., the 1^{st}, 15^{th}, 30^{th}, etc.) during which users interact with a software system, according to one embodiment. The time of month during which a user views, logs into, files a tax return with, and/or otherwise interacts with a software system is one of a number of user characteristics used by a user experience analytics model to determine users' preferences for user experience options, according to one embodiment.

FIG. 2D illustrates a time-of-year diagram 230 showing one embodiment of time-based user characteristics data that can be used to define and/or be applied to a user experience analytics model to define and/or determine users' preferences for user experience options. The time-of-year diagram 230 shows examples of time-of-year time data or time-based user characteristics data that include, but are not limited to, beginning of the year 231 (e.g., first trimester or first quarter), middle of the year 232 (e.g., second trimester or second quarter), and end of the year 233 (e.g., third trimester or third/fourth quarter), according to one embodiment. Other examples of time-of-year time data includes individual months, tax season 234, and non-tax season 235 during which users interact with a software system, according to one embodiment. The time of year during which a user views, logs into, files a tax return with, and/or otherwise interacts with a software system is one of a number of user characteristics used by a user experience analytics model to determine users' preferences for user experience options, according to one embodiment.

In one embodiment the user characteristic of time data also includes duration of interaction by a user with a software system. For example, time data includes how long the user answers questions, how many different user interface display pages the user visits, how long the user remains logged in, how many times the user logs in, how much time passes between successive logins, how much time passes between first and last login, and the like, according to one embodiment.

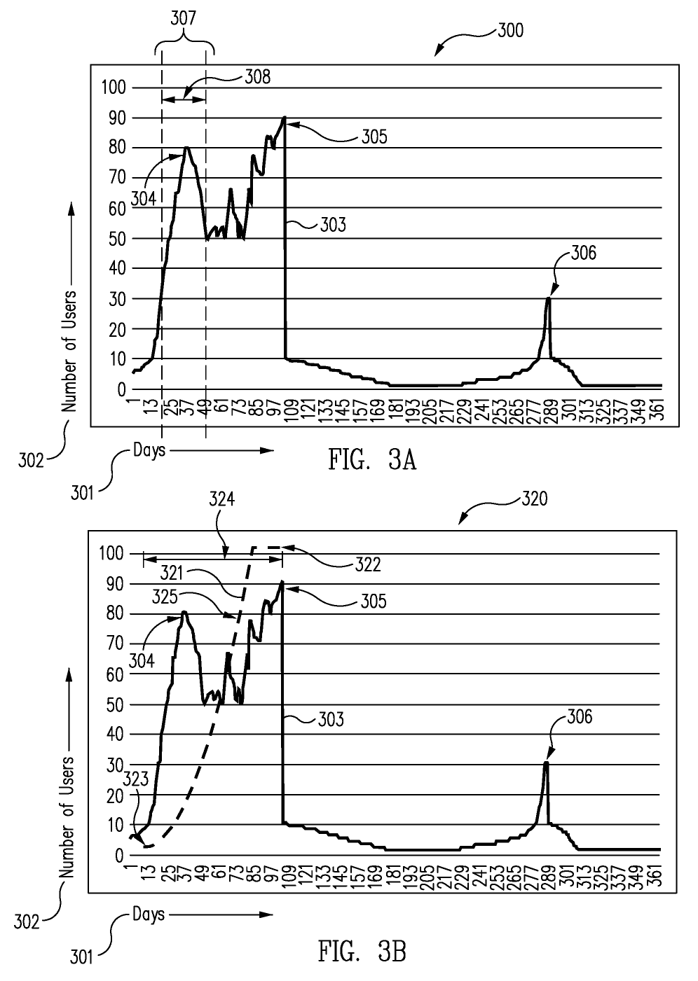

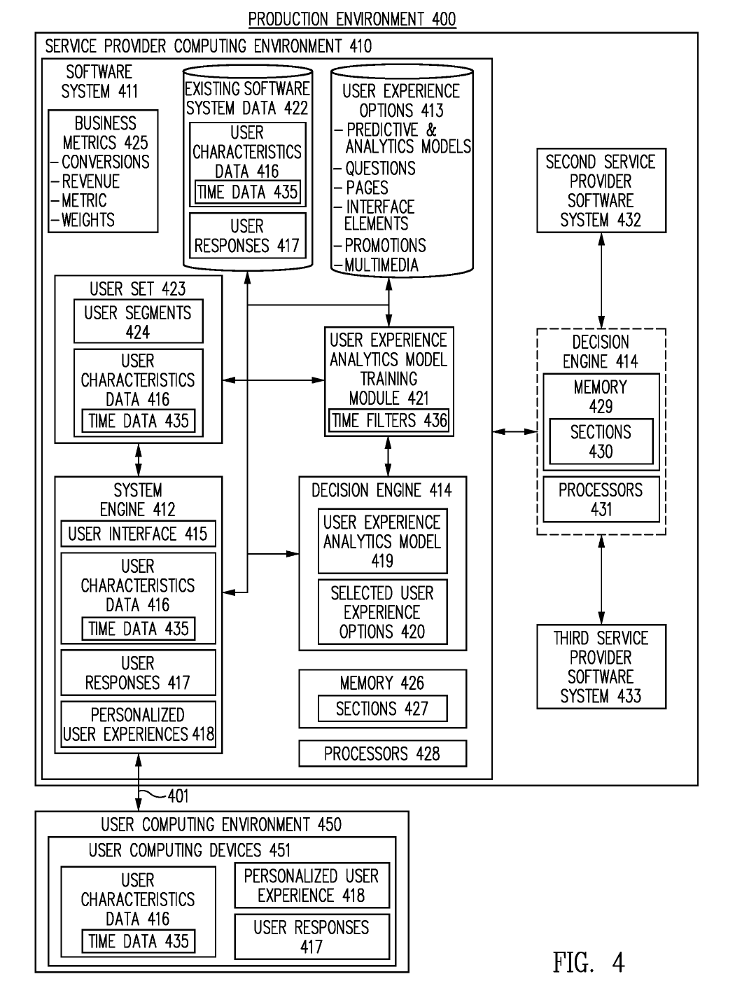

FIGS. 3A and 3B illustrate example diagrams of time filtering techniques (e.g., or time settings) that are used by a production environment or a software system in a production environment to guide, shape, define and/or direct at least part of the operation of a user experience analytics model in determining users' preferences for user experience options in a software system (e.g., a tax return preparation system). To improve the likelihood of providing preferred user experience options to current users, the software system trains the user experience analytics model by time filtering the data samples that are used in training the user experience analytics model, according to one embodiment. The data samples include data representing existing user characteristics and data representing existing user actions/responses collected about/from prior users of the software system. The software system time filters the data samples by sizing and applying a sliding window and/or a decaying window to the data samples, according to one embodiment. The software system omits data samples that are outside of the sliding window, according to one embodiment. The software system omits data samples that are outside of the decaying window, and the decaying window causes the software system to emphasize (e.g., weight) the influence of newer data samples over older data samples, according to one embodiment.

FIG. 3A illustrates an example of a graph 300 that shows data samples of users' interactions with a software system over the course of a year, and that illustrates an application of a sliding window (or sliding window filter) to the data samples, to improve the likelihood of providing preferred user experience options to users with a user experience analytics model, according to one embodiment. The graph 300 includes an x-axis 301 representing days of the year, and includes a y-axis 302 representing numbers of users (e.g., in thousands or millions) of the tax return preparation system, in a year, according to one embodiment. The graph 300 includes a plot line 303 that represents daily usage of a software system by users over the course of a year, according to one embodiment. The plot line 303 includes a first peak 304 and a second peak 305, which indicate higher-than-average usage near the beginning of the regular US tax season and near the end of the regular US tax season, according to one embodiment. The plot line 303 also includes a third peak 306, which represents a deadline for users who take a 6-month extension from the April 15^{th} tax filing deadline, according to one embodiment.

The software system described herein uses data samples to train a user experience analytics model, according to one embodiment. The accuracy of the user experience analytics model to statistically estimate and/or statistically determine users' preferences for user experience options depends on which data samples of prior users are used to train the user experience analytics model, according to one embodiment. Similar to how public support for one candidate over another can change with time, users preferences for one user experience option over another can also change over time. Sometimes user preference change in response to external stimuli, such as a magazine or newspaper article, while other times user preferences change because available features within the software system have been changed over time. Thus, determining preferences of current users for user experience options, based on obsolete or somewhat irrelevant data samples, can cause the user experience analytics model to inaccurately predict current users' preferences for currently available user experience options.

A sliding window 307 is applied to the samples represented by the plot line 303 to limit the data samples of prior users to those which the software system determines are relevant (or most relevant) for training the user experience analytics model, according to one embodiment. The sliding window 307 is configured as a binary filter that excludes all data samples that are outside a width of the window 308, according to one embodiment. The software system statistically determines and adjusts the location (within the entire sample set) of the sliding window 307 and statistically determines and adjusts the width of the window 308, based on levels of uncertainty, levels of performance, quantity of variance, levels of sensitivity, and/or other characteristics of the user experience analytics model that is generated from the data samples that fit within the sliding window 307, according to one embodiment.

The width of the window 308 for the sliding window 307 can be dynamically and adaptively set and adjusted across a variety of values, according to one embodiment. For example, the width of the window 308 can span a number of hours, a day, a number of days, a week, a number of weeks, a month, a quarter, a year, or some other predetermined or adjustable period of time, according to one embodiment. The width of the window 308 can also span one or more pre-determined or characteristic-based number of data samples, according to one embodiment. For example, the width of the window 308 can be set to span 100,000 data samples, 500,000 data samples, 1,000,000 data samples, and the like, according to one embodiment. As another example, the width of the window 308 can be set to span: a number of data samples that maintains a predetermined level of uncertainty, a number of data samples that maintains a predetermined level of performance, a number of samples that maintains a predetermined quantity of variance, a number of samples that maintains a predetermined level of sensitivity, and/or a number of data samples that maintains a predetermined level of one or more other characteristics of the user experience analytics model that is generated from the data samples, according to one embodiment.

In one embodiment, the width of the window 308 is set differently for different user characteristics, according to one embodiment. For example, if the user characteristic is users who use a mobile device to login to the software system, then the width of the window 308 may be set to 500,000 data samples that immediately precede the present date. As another example, if the user characteristic is an income level greater than $170,000 per year, then the width of the window 308 may be set to include the data samples of prior users who prepare/file their tax returns during the first 2 weeks of April of the previous year, according to one embodiment. By setting the width of the window 308 differently for different user characteristics, the software system provides a more statistically accurate/predictive determination of preferences for user experience options for current users, according to one embodiment.

The software system adjusts both the width of the window 308 and the location of the window within the data sample set to optimize, improve, modify, and/or evaluate the operation, functionality, performance, and/or effectiveness of a user experience analytics model, according to one embodiment. Characteristics of the user experience analytics model can be metrics by which the width of the window 308 and/or the location of the window are adjusted, according to one embodiment. The root cause of variance between data samples is having finite quantities of data samples because a hypothetical infinite quantity of data samples would result in zero statistical uncertainty in the statistically determined preferences of current users, which are based on data samples of prior users' preferences for user experience options, according to one embodiment. Decreasing the width of the window 308 increases the level of uncertainty in the analytics model because decreasing the width of the window 308 decreases the quantity of data samples from which to make statistical predictions and/or determinations. However, decreasing the width of the window 308 increases the sensitivity of the analytics model to changes between one data sample set and another data sample set. The smaller/shorter the width of the window 308, the more sensitive the user experience analytics model will be to changes in the data sample sets for users' preferences for user experience options defined. Although a smaller/shorter window results in greater sensitivity to change, the smaller/shorter width of the window 308 corresponds to smaller numbers of samples and therefore higher likelihood of inaccuracy, i.e., uncertainty, according to one embodiment.

Modifying the user experience analytics model based on uncertainty and based on sensitivity of each have their own benefits and drawbacks, however, a balance between the contradictory characteristics of the user experience analytics model can be dynamically and adaptively determined based on users' responses, according to one embodiment. The influence and effects of sensitivity settings and uncertainty settings can be numerically quantified based on user responses to user experience options provided to the users' under a variety of sensitivity and/or uncertainty settings for the user experience analytics model, according to one embodiment. Using the dynamic and adaptive techniques for determining users' preferences for user experience options, the software system and/or the user experience analytics model is used to determine a width of the window 308 that optimizes, improves, modifies, and/or evaluates the operation, functionality, performance, and/or effectiveness of the user experience analytics model, according to one embodiment. In other words, the sensitivity, uncertainty, variance, distribution, and other statistical and non-statistical characteristics of data samples and of the user experience analytics model can be used as metrics for defining performance and effectiveness of the user experience analytics model in providing user experience options to users in accordance with the users' preferences, according to one embodiment.

FIG. 3B illustrates an example of a graph 320 that shows data samples of users' interactions with a software system over the course of a year, and that illustrates an application of a decaying window (or decaying window filter) to the data samples, to improve the likelihood of providing preferred user experience options to users with a user experience analytics model, according to one embodiment. The graph 320 includes a decaying window 321 having a window beginning 322, a window ending 323, a width of the window 324, and a decay 325, according to one embodiment. The window beginning 322, the window ending 323, and the width of the window 324 can individually or aggregately be set using one or more of the techniques described above for the sliding window 307. In one embodiment, both the sliding window 307 and the decaying window 321 can be dynamically moved or slid along a data sample set to periodically or responsively redefine the operation of the user experience analytics model. The decay 325 of the decaying window 321 can include one or more of a number of functions that deemphasize the weight of data samples in relation to the data samples' proximity to the window beginning 322, according to one embodiment. In other words, the older a data sample is, the less weight the data sample is given when defining a user experience analytics model, according to one embodiment. Example functions that are used to define the decay 325 of the decaying window 321 include, but are not limited to, exponential functions, linear functions, step functions, logarithmic functions, tangent functions, cube root functions, cubic functions, and the like, according to one embodiment.

The time data and the time filters illustrated in FIGS. 2A-2D and 3A-3B and described above are examples of temporal techniques that are applied to a user experience analytics model to identify and address user preferences that are based on or dependent upon time, according to one embodiment. Some user preferences may be affected by changes in time, and others may be time-independent. By employing time data, time filters, and/or other temporal techniques to the definition and application of a user experience analytics model, the software system optimizes, improves, and/or otherwise modifies the capacity of the user experience analytics model in identifying and providing user experience options that are preferred by the users of the software system, according to one embodiment.

FIG. 4 illustrates an example embodiment of a production environment 400 for using time data and time filters for adaptively providing personalized user experiences in a software system, e.g., a tax return preparation system. The production environment 400 includes a service provider computing environment 410 and a user computing environment 450 to deliver personalized user experiences to users of a software system, to cause the users to perform one or more particular actions (e.g., answer a sequence of questions, continue use of the software system, file a tax return, etc.), according to one embodiment. The computing environments 410 and 450 are communicatively coupled to each other with a communication channel 401, according to one embodiment.

The service provider computing environment 410 represents one or more computing systems such as, but not limited to, a server, a computing cabinet, and/or distribution center that is configured to receive, execute, and host one or more applications for access by one or more users, e.g., clients of the service provider, according to one embodiment. The service provider computing environment 410 represents a traditional data center computing environment, a virtual asset computing environment (e.g., a cloud computing environment), or a hybrid between a traditional data center computing environment and a virtual asset computing environment, to host one or more software systems, according to one embodiment. The one or more software systems can include, but are not limited to tax return preparation systems, other financial management systems, and applications that support the tax return preparation systems and/or the other financial management systems, according to one embodiment. The service provider computing environment 410 includes a software system 411 that uses time data and time filters to adaptively provide personalized user experiences to users, at least partially based on user characteristics for the users, according to one embodiment. By adaptively providing personalized user experiences, the software system 411 improves user satisfaction, increases service provider revenue, facilitates user interactions with user interfaces, and determines user preferences for user experience options, while concurrently, automatically, and seamlessly increasing user traffic to preferred/well-performing user experience options in the software system 411, according to one embodiment. The software system 411 includes various components, databases, engines, modules, and data to support using time data and time filtering to adaptively provide personalized user experiences to users of the software system 411, according to one embodiment. The software system 411 includes a system engine 412, user experience options 413, and a decision engine 414, according to one embodiment.

The system engine 412 is configured to communicate information between users and the software system 411, according to one embodiment. The system engine 412 executes/hosts a user interface 415, according to one embodiment. The system engine 412 executes/hosts the user interface 415 to receive user characteristics data 416 (including time data 435) and to receive user responses 417 from users, in response to personalized user experiences 418 provided to the users by the software system 411, according to one embodiment. The user interface 415 includes one or more user experience elements and graphical user interface tools, such as, but not limited to, buttons, slides, dialog boxes, text boxes, drop-down menus, banners, tabs, directory trees, links, audio content, video content, and/or other multimedia content for communicating information to the user and for receiving the information from users, according to one embodiment.

The system engine 412 and/or the software system 411 communicates with the user through the user computing environment 450, according to one embodiment. The user computing environment 450 includes user computing devices 451 that are representative of computing devices or computing systems used by users to access, view, operate, and/or otherwise interact with the software system 411, according to one embodiment. The term “users” and “user computing devices” are used interchangeably to represent the users of the software system 411, according to one embodiment. Through the user computing devices 451, users provide the user characteristics data 416 (including time data 435) and provide the user responses 417 to the software system 411, in response to receipt of the personalized user experiences 418, according to one embodiment.

The user characteristics data 416 represents user characteristics for users of the software system 411, according to one embodiment. The user characteristics data 416 can include information from existing software system data 422, such as one or more previous years' tax return data for a particular user and previous user interactions with the software system 411. The user characteristics data 416 is stored in a data store, a database, and/or a data structure, according to one embodiment. The user characteristics data 416 also includes information that the software system 411 gathers directly from one or more external sources such as, but not limited to, a payroll management company, state agencies, federal agencies, employers, military records, public records, private companies, and the like, according to one embodiment. The user characteristics data 416 includes time data 435, which includes, but is not limited to, data indicating frequency of user interaction with the software system, data indicating duration of user interaction with the software system, data indicating a number of user interactions with the software system, data indicating one or more times of a day of user interactions with the software system, data indicating one or more days of a week of user interactions with the software system, data indicating one or more times of a month of user interactions with the software system, data indicating one or more times of a year of user interactions with the software system, and the like, according to one embodiment. Additional examples of the user characteristics (represented by the user characteristics data 416) include, but are not limited to, data indicating user computing system characteristics (e.g., browser type, applications used, device type, operating system, etc.), data indicating time-related information (hour of day, day of week, etc.), data indicating geographical information (latitude, longitude, designated market area region, etc.), data indicating external and independent marketing segments, data identifying an external referrer of the user (e.g., paid search, ad click, targeted email, etc.), data indicating a number of visits made to a service provider website, a user's name, a Social Security number, government identification, a driver's license number, a date of birth, an address, a zip code, a home ownership status, a marital status, an annual income, a job title, an employer's address, spousal information, children's information, asset information, medical history, occupation, information regarding dependents, salary and wages, interest income, dividend income, business income, farm income, capital gain income, pension income, IRA distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently used, that can be used, or that may be used in the future, in a financial system, or in the preparation of a user's tax return, according to various embodiments.

The system engine 412 provides personalized user experiences 418, by populating and/or using one or more user experience options 413 in the personalized user experience 418, according to one embodiment. The user experience options 413 include predictive and analytics models that can be used to determine relevant topics to present to the user; questions to present to the user; sequences of topics to present to the user; sequences of questions to present to the user; types of marketing content; and the like, according to one embodiment. The user experience options 413 also include, but are not limited to, questions, webpages, sequences of pages, colors, interface elements, positioning of interface elements within webpages, promotions that can be offered to users, audio files, video files, other multimedia, and the like, according to various embodiments.

Users of the software system 411 will have individual preferences, technical competency levels, levels of education, levels of comfort using digital technologies, and other distinctive or individual characteristics that increase the value of personalized user experiences of the software system 411 for the users. To improve the likelihood of satisfaction of the user with his experience with the software system 411, the system engine 412 selectively applies one or more of the user experience options 413 to the personalized user experiences 418 while facilitating interactions between the software system 411 and the users, according to one embodiment.

The software system 411 uses the decision engine 414 to identify which user experience options 413 to apply to the personalized user experiences 418, in order to facilitate or promote one or more particular user actions (e.g., such as completing a set of questions, continuing to use the software system 411, filing a tax return with the software system 411, etc.), according to one embodiment. The decision engine 414 is configured to receive the user characteristics data 416, receive the user experience options 413, and select one or more of the user experience options 413 for the system engine 412 to integrate into the personalized user experiences 418 for users of the software system 411, according to one embodiment. The decision engine 414 uses time data 435 in selecting and/or identifying one or more of the user experience options 413 because some preferences for user experience options 413 can be more clearly identified by using time data 435 than by using other user characteristics in the absence of the time data 435, according to one embodiment.

The decision engine 414 applies the user characteristics data 416 and the user experience options 413 to a user experience analytics model 419, to determine which user experience options 413 to apply to users with particular user characteristics, according to one embodiment. The user experience analytics model 419 returns distribution frequency rates for user experience options 413, based on the user characteristics data 416, according to one embodiment. The distribution frequency rates define a frequency with which users having particular user characteristics are directed to particular user experience options, according to one embodiment. In one embodiment, users are directed to particular user experience options, for example, via a universal resource locator (“URL”). In one embodiment, selected user experience options are delivered to users by modifying the content of personalized user experiences 418. “Directing users to user experience options” is used interchangeably with “providing users with user experience options”, according to one embodiment.

The decision engine 414 uses the distribution frequency rates from the user experience analytics model 419 to generate a weighted pseudo-random number that represents the one or more user experience options that are to be provided to a user based on the user's user characteristics data, according to one embodiment. Examples of distribution frequency rates include 0.2 for a first user experience option, 0.5 for a second user experience option, and 0.3 for a combination of one or more other user experience options, according to one embodiment. In practice, 0.2, 0.5, and 0.3 distribution frequency rates means that for a particular user characteristic, 2 out of 10 users receive the first user experience option, 5 out of 10 users receive the second user experience option, and 3 out of 10 users receive the combination of one or more other user experience options, according to one embodiment. The decision engine 414 uses the distribution frequency rates and the weighted pseudo-random number to identify selected user experience options 420, for delivery to the user, according to one embodiment.

While the user experience options 413 are described as experience elements/features that are added to the personalized user experiences 418, the selected user experience options 420 can also include the omission of one or more user experience options 413. For example, the user experience analytics model 419 can be configured to generate distribution frequency rates of 0.8 and 0.2 for determining whether or not to display large icons in the personalized user experiences 418, according to whether the age, income level, employment status, education level, or other user characteristic is above or below one or more thresholds that are set within the user experience analytics model 419, according to one embodiment. In other words, the output of the user experience analytics model 419 can be Boolean and can simply determine whether a user receives a user experience option or not, based on the user's user characteristics, according to one embodiment.

The software system 411 uses, executes, and/or operates a user experience analytics model training module 421 to train (e.g., initialize and update) the user experience analytics model 419, according to one embodiment. The user experience analytics model training module 421 retrieves user characteristics data 416 (including time data 435) from the existing software system data 422 and retrieves user experience options 413 for use in training the user experience analytics model 419, according to one embodiment. The user experience analytics model training module 421 initializes and/or updates the user experience analytics model 419 using techniques that include, but are not limited to, regression, logistic regression, decision trees, artificial neural networks, support vector machines, linear regression, nearest neighbor methods, distance based methods, Naive Bayes, linear discriminant analysis, k-nearest neighbor algorithm, and/or another mathematical, statistical, logical, or relational algorithms to determine correlations and/or other relationships between the user characteristics data and the performance of user experience options on segments of users, according to one embodiment.

As discussed above, in connection with FIGS. 3A and 3B, the user experience analytics model training module 421 applies one or more time filters 436 to the existing software system data 422 while training the user experience analytics model 419, according to one embodiment. The time filters 436 include one or more of a sliding window, a decaying window, or other time-based data sample filter, according to one embodiment. The user experience analytics model training module applies the time filters 436 to the user characteristics data 416 and/or the user responses 417 to reduce the quantity of data samples and/or to adjust the weight of the samples used in training the user experience analytics model 419 to determine users' preferences for the user experience options 413, according to one embodiment.

In one embodiment, the user experience analytics model training module 421 defines a user set 423 that is based on all or part of the users that have interacted with the software system 411 and/or for whom user characteristics data 416 has been gathered or received. The user experience analytics model training module 421 defines a number of user segments 424 around subsets of users have one more user characteristics in common. In other words, the user segments 424 are subsets of the user set 423, and each of the user segments 424 have one or more user characteristics in common, according to one embodiment.

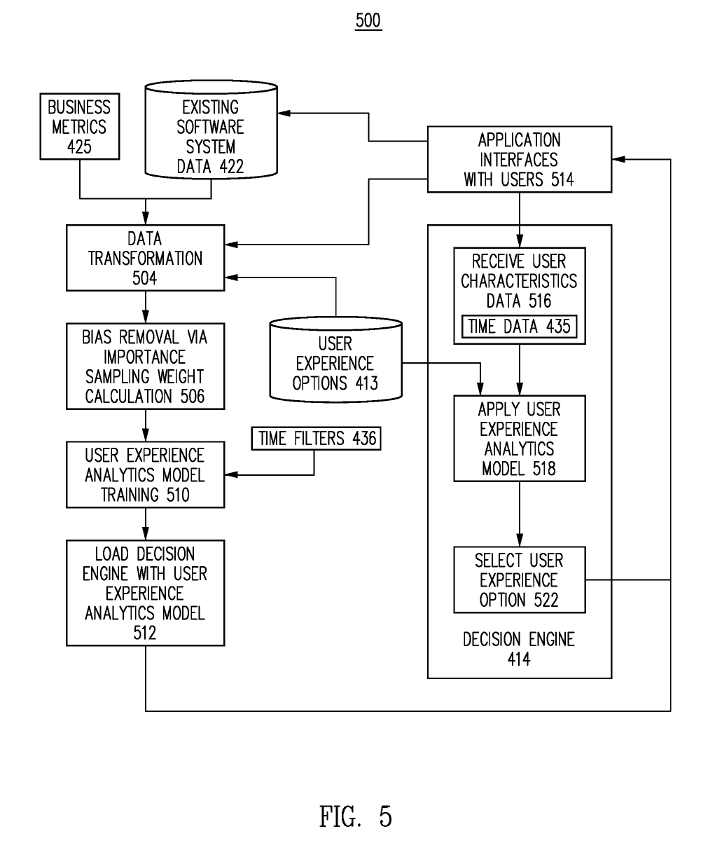

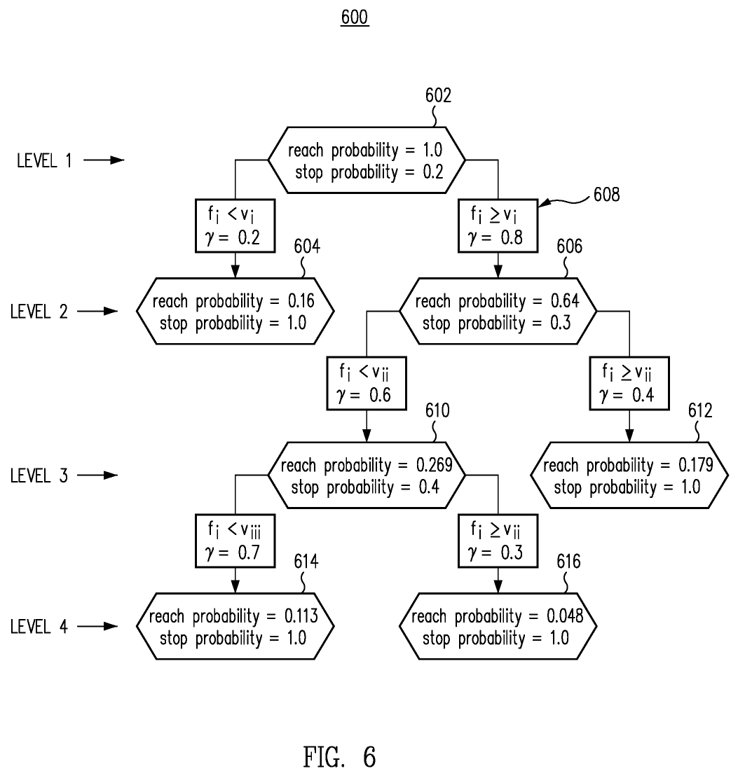

The user experience analytics model training module 421 trains the user experience analytics model 419 by generating a decision tree, based on how particular user experience options 413 perform with particular user segments 424 (i.e., subsets of the user set 423), according to one embodiment. The user experience analytics model training module 421 generates a decision tree as part of the analytics logic for the user experience analytics model 419, to facilitate generating distribution frequency rates and to facilitate distributing user experience options 413 in accordance with the distribution frequency rates, according to one embodiment. The processes 500, 700, and 1100, of FIGS. 5, 7, and 11 respectively, disclose particular embodiments that may be used by the user experience analytics model training module 421 for initializing and/or updating the user experience analytics model 419, according to one embodiment.

The software system 411 adapts to user responses 417 received from users, to update the user experience analytics model 419, and to dynamically and adaptively improve the personalized user experiences 418, according to one embodiment. The software system 411 is configured to store/update user characteristics data 416 and user responses 417, as the existing software system data 422, during the operation of the software system 411. After a predetermined period of time, such as, but not limited to, an hour, a day, semi-weekly, weekly, biweekly, and the like, the user experience analytics model training module 421 retrieves the user experience options 413, the user characteristics data 416, the user responses 417, and the business metrics 425 to determine the performance of the user experience options 413 and to update the user experience analytics model 419, based on the performance of the user experience options 413, according to one embodiment. Particular embodiments for initializing and/or updating the user experience analytics model 419 are disclosed below in the processes 500, 700, and 1100, of FIGS. 5, 7, and 11 respectively, according to one embodiment.

The business metrics 425 include, but are not limited to, the various metrics used by the software system 411 and/or the service provider of the software system 411 to evaluate the success, failures and/or the performance of the user experience options 413, according to one embodiment. The business metrics 425 include, but are not limited to, number of conversions of users from potential customers to paying customers, the percentage of conversions of potential customers to paying users, quantities of revenue, rates of revenue collected per user (e.g., average revenue collected per user), increases/decreases in revenue as compared to one or more previous years, months, weeks, days, and metric weights that are applied to conversions and revenues to establish a relative importance of conversions verses revenue generation. The business metrics 425 can also include records of other actions taken by users, such as, but not limited to, numbers of questions answered, duration of use of the software system 411, number of pages or user experience displays visited within a software system 411, use of customer support, and the like, according to one embodiment.

The business metrics 425 can also include metrics that are specific to the software system 411, according to one embodiment. For example, levels of sensitivity, levels of variance, levels of uncertainty, and/or other characteristics of the user experience analytics model 419 (or the output resulting from the analytics model) can be metrics used by the software system 411 to adjust and/or retrain the operation of one or more components or modules within the software system 411, according to one embodiment.

The software system 411 includes memory 426 that has one or more sections 427 allocated for the operation or support of the software system 411, according to one embodiment. For example, the memory 426 and/or the one or more sections 427 are allocated to the storing and/or processing of: user characteristics data 416, user responses 417, the user experience analytics model 419, the user experience analytics model training module 421, and the like, according to one embodiment. The software system 411 also includes one or more processors 428 configured to execute and/or support the operations of the software system 411, according to one embodiment.

In one embodiment, the decision engine 414 is integrated into the software system 411 to support operation of the software system 411. In one embodiment, the decision engine 414 is hosted in the service provider computing environment 410 and is allocated computing resources, e.g., memory 429 having sections 430, and one or more processors 431, that are different than some of the computing resources of the software system 411. The decision engine 414 is hosted in the service provider computing environment 410 in order to provide support for the software system 411, in addition to providing support for a second service provider software system 432 and/or a third service provider software system 433, according to one embodiment. Although a second service provider software system 432 and a third service provider software system 433 are illustrated and described herein, the decision engine 414 can be configured to operationally support fewer or more software systems, according to various embodiments.

The user experience analytics model training module 421 initializes and/or updates the user experience analytics model 419 from a backend or off-line system, rather than as an integrated online process, according to one embodiment. For example, rather than sharing memory and processor resources with the software system 411, the user experience analytics model training module 421 is allocated dedicated memory and processor resources to facilitate secure and more timely processing of user characteristics of new and existing software system data, and of user experience options for training the user experience analytics model 419. In another embodiment, the user experience analytics model training module 421 is integrated into the software system 411, as illustrated, and shares one or more hardware resources with the decision engine 414, within the service provider computing environment 410, according to one embodiment.

### Process

FIG. 5 illustrates a process 500 for training (e.g., initializing and updating) the user experience analytics model 419, at least partially based on time data and time filtering, according to one embodiment.

At operation 504, the process performs data transformation, to prepare existing software system data 422 and data representing business metrics 425 for processing, according to one embodiment. The process performs data transformation on the existing software system data 422 (inclusive of user characteristics data and user responses), on user experience options 413, and on business metrics 425. Data transformation includes, but is not limited to, formatting, rearranging, organizing, ranking, and/or prioritizing the data to enable it to be uniformly processed or analyzed by one or more equations and/or algorithms, according to one embodiment. Operation 504 proceeds to operation 506, according to one embodiment.

At operation 506, the process performs bias removal via importance sampling weight calculation, according to one embodiment. The process performs bias removal on the business metrics, such as conversions and revenue, as well as on user responses for the existing software system data 422 to account for particular user characteristics that were targeted, that are different, or that otherwise bias the user responses and/or the business metrics, according to one embodiment. Operation 506 proceeds to operation 510, according to one embodiment.

At operation 510, the process performs user experience model training, according to one embodiment. The process uses the same algorithm to initialize and to update the user experience analytics model, according to one embodiment. The process trains the user experience analytics model by using techniques that include, but are not limited to, regression, logistic regression, decision trees, artificial neural networks, support vector machines, linear regression, nearest neighbor methods, distance based methods, Naive Bayes, linear discriminant analysis, k-nearest neighbor algorithm, and/or another mathematical, statistical, logical, or relational algorithms to determine correlations and/or other relationships between the user characteristics data and the performance of user experience options on segments of users, according to one embodiment. The process applies one or more time filters 436 to the training process to filter, exclude, and/or selectively process particular data samples (e.g., user characteristics and user responses of prior users) while training and/or updating the user experience analytics model, according to one embodiment. Operation 510 proceeds to operation 512, according to one embodiment.

In one embodiment, the process 500 performs user experience model training by creating, validating, and/or modifying a decision tree. FIG. 6 illustrates an example of a decision tree 600 that can be used to determine at least part of the algorithm, logic, and/or function of the user experience analytics model that selects which user experience options to deliver to users based on user characteristics, to facilitate providing personalized user experiences in the software system 411. The decision tree 600 includes nodes 602, 604, 606, 610, 612, 614, and 616 (collectively, nodes 602-616) connected together through edges and edge logic. The edge logic defines the rules and parameters for traversing from a parent node to a child node in the decision tree 600, according to one embodiment. Each of the nodes 602-616 includes node properties, such as a reach probability, a stop probability, a user experience option, and a user segment.

The reach probability is the probability that a person coming into the stream of the decision tree will reach a particular node, according to one embodiment. Because all users are evaluated by the node 602, the reach probability of the node 602 is 1, indicating that there is a 100% chance that a user's characteristics will be evaluated by the node 602. Node 604 has a reach probability of 0.16 and node 606 has a reach probability of 0.64. Accordingly, of all the user traffic that is applied to the decision tree 600, node 604 will receive 16% of the user traffic and node 606 will receive 64% of the user traffic, on average, according to one embodiment. Because each node is assigned at least one user experience option, and because the reach probabilities of the nodes 602-616 indicate the frequency with which a user experience option is provided to users of a user segment, the reach probabilities are the distribution frequency rates, described above in relation to the production environment 400 (shown in FIG. 4). In other words, the reach probabilities determine a frequency rate by which to distribute user experience options to users of user segments, based on the users' characteristics, according to one embodiment.

In one embodiment, each node represents a segment of users to whom one of two user experience options is provided. The users of a segment each receive one of two user experience options in accordance with the distribution frequency rate, according to one embodiment. The software system 411 dynamically adapts the distribution frequency rate, based on the evolving performance of user experience options among the users of each segment, according to one embodiment. So, while some users of a segment might initially receive a first user experience option at a distribution frequency rate of 0.7, with time users of the segment may receive the first user experience option at a distribution frequency rate than evolves toward 0.0 or that evolves towards 1.0, based on the responses/actions of the users of the segment that receive the first user experience. Accordingly, the software system validates the performance of one user experience option among the users of a segment, while testing the performance of another user experience option among the other users of the segment, to eventually determine which of two or more user experience options is most preferred by the users of a segment, according to one embodiment.

The stop probability is the probability that the performance of a particular node without children nodes (for a user segment) will be better than the performance of children nodes split from the particular node, according to one embodiment. In other words, the stop probability is the probability that the performance of a leaf node is greater than the performance of creating two children nodes from a leaf node to convert the leaf node to a parent node. If a stop probability is 1, then the probability of stopping the further evaluation of the data sample is 100%. If a stop probability is less than 1, then the stop probability represents a likelihood that the decision tree will apply the user experience option of the current node rather than evaluating a further path through the nodes of the decision tree 600, according to one embodiment. In one embodiment, if a data sample does not receive the user experience option of a parent node, then the data sample receives the user experience option of a descendent node.

At least two user experience options is assigned to each node (i.e., to each segment of users associated with a node) of the decision tree 600. In one embodiment, a user experience option is defined as omitting a user experience element (e.g., a button, a text box, a question, a webpage, etc.) from a user's personalized user experience. In one embodiment, a user experience option is defined as adding a user experience element or applying an analytics model, a sequence, or other user experience tool to a user's personalized user experience. In one embodiment, the user experience analytics model includes a different decision tree for each user experience option, so that each of the nodes in the decision tree represent a binary decision to apply or to not apply a user experience option to the user's personalized user experience. In one embodiment, the user experience analytics model includes a different decision tree for each user characteristic, and each of the nodes in the decision tree represent the application of two of a number of user experience options to users' personalized user experience (e.g., in accordance with distribution frequency rates for the user experience options and for the particular segment of users). In one embodiment, the user experience analytics model includes a decision tree having edge logic that evaluates different user characteristics and each node of the decision tree represent the application of one of a number of user experience options, and the node paths can include a variety user experience options (rather than a Boolean application of a single user experience option).

The user segment is a segment or portion of users who have at least one user characteristic in common. For example, a user set can be bifurcated into two user segments, in which a first user segment includes users who are younger than 30 years old and the second user segment includes users who are at least 30 years old, according to one embodiment.

Each of the nodes 602-616 belong to a level that is defined by 1 plus the number of connections between the node of interest and the root node. Because the root node is the top node in the decision tree 600, the root node for the decision tree 600 is the node 602. Accordingly, node 602 belongs to level 1, nodes 604 and 606 belong to level 2, nodes 610 and 612 belong to level 3, and nodes 614 and 616 belong to level 4 of the decision tree 600, according to one embodiment.

In one embodiment, the user experience option for a node is related to the level of the node in the decision tree 600. In one embodiment, all levels of one decision tree provide binary options for whether or not to apply a single user experience option to a user's personalized user experience. In one embodiment, each level of the decision tree is associated with a different user experience option, and each level of the decision tree provides binary options for whether or not to apply the user experience option associated with that level to a user's personalized user experience. In one embodiment, user experience options are allocated to nodes within the decision tree, based on the dominance or capacity of the user experience option to affect the actions of users, with more dominant user experience options being assigned to nodes that are closer to the root node.

In one embodiment, edge logic includes an edge frequency (γ) for which a single user characteristic (fᵢ) satisfies a threshold (νᵢ). The edge logic provides rules and the average frequency by which data samples traverse parent nodes to children nodes. The edge logic 608 indicates that the probability of the user characteristic (fᵢ) being greater than or equal to the threshold (νᵢ) is 0.8, and that the probability of the user characteristic (fᵢ) being less than the threshold (νᵢ) is 0.2, according to one embodiment. The reach probability of a child node is the product of the edge frequency (γ) multiplied with the stop probability subtracted from one. For example, the reach probability of node 606 is 0.64 which is equal to (1—stop probability of node 602)*(γ=0.8). In one embodiment, the thresholds for descendent nodes are different than all ancestor nodes because each descendent node already satisfies or inherits all of the characteristics of the descendent node's ancestor nodes.

Returning to the process 500 of FIG. 5, at operation 512, the process loads the decision engine with the user experience analytics model, according to one embodiment. Operation 512 proceeds to operation 514, according to one embodiment.

At operation 514, an application interfaces with users, according to one embodiment. The application interfaces with users by providing the users with questions to acquire user responses and/or to acquire user characteristics, according to one embodiment. The application interfaces with users by collecting clickstream data, IP address information, location of the user, operating system used by the user, user computing device identifiers, and other user characteristics data, according to one embodiment. The application and the decision engine save business metrics, user characteristics data, and/or user responses as existing software system data 422, according to one embodiment. The term “application” is used interchangeably with the term “software system”, according to one embodiment. Operation 514 concurrently proceeds to operation 504 to update the user experience analytics model, and proceeds to operation 516 to apply the user experience analytics model to information received from the users, according to one embodiment.

At operation 516, the decision engine 414 receives user characteristics data, including time data 435, according to one embodiment. Operation 516 proceeds to operation 518, according to one embodiment.

At operation 518, the decision engine 414 applies the user characteristics data and the user experience options 413 to the user experience analytics model, according to one embodiment. The decision engine 414 applies the user characteristics data and the user experience options 413 to the user experience analytics model to determine the distribution frequency rates for which a particular user experience option is to be distributed to users having one or more of the user characteristics received during operation 516, according to one embodiment. Operation 518 proceeds to operation 522, according to one embodiment.

At operation 522, the decision engine 414 selects a user experience option, according to one embodiment. The decision engine 414 selects a user experience option based on the distribution frequency rates generated by the user experience analytics model in response to receipt of user characteristics data and the segment of users associated with a user. The decision engine 414 generates a pseudo-random number that is weighted according to the distribution frequency rates generated by the user experience analytics model, according to one embodiment. For example, if the user experience analytics model generates distribution frequency rates of 0.8 for filling a user experience display with a background color of red and 0.2 for filling a user experience display with a background color of blue, then the decision engine 414 generates a binary number which will indicate selecting a blue background color 8 out of 10 times and will indicate selecting a red background color 2 out of 10 times, on average, according to one embodiment. Because computing systems typically generate “random” numbers using algorithms and clocks, a “random” number generated by a computing system is referred to as a “pseudo-random” number.

The selected user experience option is provided to the user because the user experience option is identified as a preference user experience option for the particular user, according to one embodiment.

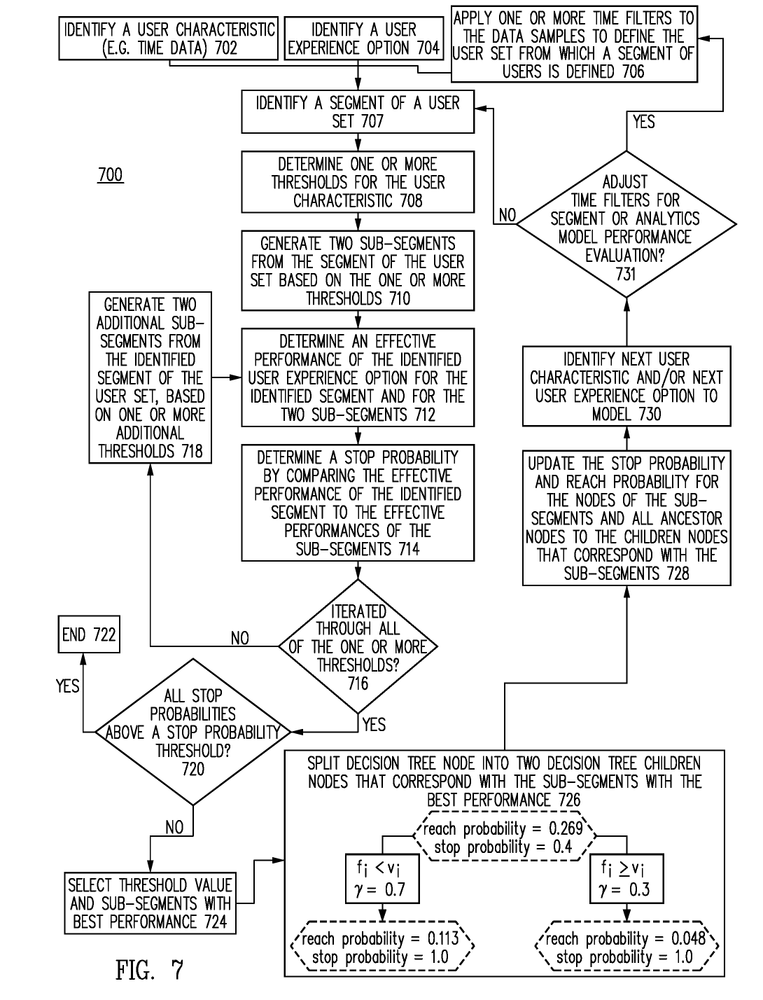

FIG. 7 illustrates an example of a process 700 that is employed or executed by the software system 411 of the production environment 400, to use time data and time filtering to periodically update the user experience analytics model 419, according to one embodiment. By periodically updating the user experience analytics model and/or by defining/initializing the user experience analytics model 419, a software system (e.g., a tax return preparation system or other finance management system) can reap the benefits of deploying user experience options that are immediately effective on users (with a probabilistic certainty) while concurrently and adaptively testing user responses to other stimuli, e.g., other user experience options, to improve user satisfaction with the personalized user experience provided by the software system 411, according to one embodiment.

At operation 702, the process identifies a user characteristic (e.g., time data), according to one embodiment. As described above, user characteristics can include time data, personal identification information, income information, tax-related information, clickstream information, geographic location of the user, an IP address or other computing or other user computing device identification information, family information about the user, and the like, according to various embodiments. The process performs operation 702 before, in between, after, or concurrently with operation 704 and/or operation 706, according to one embodiment. Operation 702 proceeds to operation 707, according to one embodiment.

At operation 704, the process identifies a user experience option, according to one embodiment. The user experience option identified by the process is used by the process to define nodes, node properties, and edge logic for traversing from parent nodes to children nodes, according to one embodiment. In one embodiment, identifying a user experience option includes identifying a plurality of user experience options, according to one embodiment. In one embodiment, operation 704 occurs prior to operation 702, after operation 702, or concurrently with operation 702, according to one embodiment. Operation 704 proceeds to operation 707, according to one embodiment.

At operation 706, the process applies one or more time filters to the data samples to define the user set from which a segment of users is defined, according to one embodiment. The time filters applied to the data samples of prior users' user characteristics data and/or user responses include sliding window filters and/or decaying window filters, according to one embodiment. The time filters are iteratively sized and time-located within the data samples to achieve one or more characteristics for the user experience analytics model and/or for the output of the user experience analytics model, according to one embodiment. The process performs operation 706 before, in between, after, or concurrently with operation 702 and/or operation 704, according to one embodiment. Operation 706 proceeds to operation 707, according to one embodiment.

At operation 707 the process identifies a segment of a user set, according to one embodiment. The segment may be the entirety of the user set, may include recent users of the user set, may include users who have interacted with a software system over a predetermined period of time (e.g., 8 during a previous year), or may be any other subset of the user set which has one or more user characteristics in common, according to one embodiment. The segment is defined from the portion of all available data samples that are passed through one or more of the time filters of operation 706, according to one embodiment. Operation 707 proceeds to operation 708, according to one embodiment.

At operation 708, the process determines one or more thresholds for the user characteristic, according to one embodiment. By determining the one or more thresholds, the process is able to define additional segments of users, to determine if the identified user experience option more effectively causes one segment of users to perform a particular action better than another segment of users, according to one embodiment. In other words, a threshold value such as 35 years of age, for a user characteristic of age, can be used to bifurcate a segment of users of all ages into to a sub-segment of users who are less than 35 years old and a sub-segment of users who are at least 35 years old, according to one embodiment. Operation 708 proceeds to operation 710, according to one embodiment.

At operation 710, the process generates two sub-segments from the segment of the user set, based on the one or more thresholds, according to one embodiment. The operation 710 proceeds to operation 712, according to one embodiment.

At operation 712, the process determines an effective performance of the identified user experience option for the identified segment and for the two sub-segments, according to one embodiment. The effective performance of the user experience option for the identified segment and/or for the two sub-segments is a probabilistic distribution that users (who are defined by the segments and/or sub-segments) will perform one or more predetermined actions, according to one embodiment. Examples of the determined actions include, but are not limited to, answering questions, remaining logged into a user session of the software system, filing a tax return, progressing through a sequence of topics or a sequence of questions, clicking a button, interacting with a particular user experience object or element, paying for a service, submitting credit card information, providing an email address, providing a telephone number, and the like, according to various embodiments. In one embodiment, the process uses Thompson Sampling on user responses to user experience options, at least partially based on user characteristics data, to determine a sample mean and a sample variance for the performance of user experience options on a segment of users, according to one embodiment. In one embodiment, the process uses Thompson Sampling blending or other mathematical techniques for calculating an average of multiple Thompson Samples to determine an effective performance of a user experience option on a segment or sub-segment, according to one embodiment. Operation 712 proceeds to operation 714, according to one embodiment.

At operation 714, the process determines a stop probability by comparing the effective performance of the identified segment to the effective performances of the two sub-segments of the identified segment, according to one embodiment. The stop probability is the probability that the performance of the identified segment is greater than the effective performance of the two sub-segments, according to one embodiment. In terms of nodes in a decision tree, the stop probability is the probability that the effective performance of a user experience option that is associated with a parent node is greater than an effective performance of user experience options that are associated with children nodes, according to one embodiment. A low stop probability indicates that the likelihood of gaining additional effective performance from the user experience analytics model will likely be gained from splitting an identified segment into two sub-segments, according to one embodiment. Operation 714 proceeds to operation 716, according to one embodiment.

At operation 716, the process determines if the process has iterated through all identified thresholds, according to one embodiment. For user characteristics having binary or Boolean outcomes such as yes or no, there may not be multiple thresholds to iterate through. However, if the user characteristics that are used to define part of the model have continuous values, e.g., users' ages, user income, and the like, then the process advantageously identifies and recurses through the multiple thresholds (e.g., through multiple age ranges or income ranges) to test the effective performance of a user experience option against variations of sub-segments, according to one embodiment. If the process completes iterating through all of the one or more thresholds, operation 716 proceeds to operation 720, according to one embodiment. If the process has not iterated through all of the one or more thresholds, operation 716 proceeds to operation 718, according to one embodiment.

At operation 718, the process generates two additional sub-segments from the identified segment of the user set, based on one or more additional thresholds, according to one embodiment. Operation 718 proceeds to operation 712, according to one embodiment.

At operation 720, the process determines if all stop probabilities are above a stop probability threshold, according to one embodiment. If all stop probabilities are above a stop probability threshold, e.g., 0.8, the operation 720 proceeds to operation 722 to end the process, according to one embodiment. If at least one of the stop probabilities is not above the stop probability threshold, operation 720 proceeds to operation 724.

At operation 724, the process selects a threshold value and the sub-segments with the best performance, according to one embodiment. The effective performance of segments and sub-segments is a probabilistic distribution having a sample mean and a sample variance. In one embodiment, the best performance includes a combination of a threshold and a user experience option that results in the highest sample mean. In one embodiment, the best performance includes a combination of a threshold and a user experience option that produces the lowest sample variance. In one embodiment, the best performance includes a combination of a threshold and a user experience option that produces the highest sample mean and/or the lowest sample variance while having a sample mean that is greater than a minimum threshold and/or while having a sample variance that is below a maximum sample variance threshold. Operation 724 proceeds to operation 726, according to one embodiment.

At operation 726, the process splits a decision tree node into two decision tree children nodes that correspond with the sub-segments with the best performance, according to one embodiment. When creating children nodes, the node properties (e.g., the reach probabilities, stop probabilities, user experience options, etc.) are defined for the children nodes and the node properties for the parent node of the split are also updated. Operation 726 proceeds to operation 728, according to one embodiment.

At operation 728, the process updates the stop probability and the reach probability for the nodes of the sub-segments and all ancestor nodes to the children nodes that correspond with the sub-segments, according to one embodiment. For example, because the sum of the reach probabilities for the nodes of the decision tree is 1, the reach probabilities of ancestor nodes are updated to reflect the addition of the children node reach probabilities, according to one embodiment. Operation 728 proceeds to operation 730, according to one embodiment.

At operation 730, the process identifies a next user characteristic and/or a next user experience option to model, according to one embodiment. Operation 730 proceeds to operation 731, according to one embodiment.

At operation 731, the process determines whether to adjust time filters for the segment or analytics model performance, according to one embodiment. If one or more characteristics of the segment or of the user experience analytics model are outside of one or more predetermined thresholds or statistically have room for improvement, the operation 731 proceeds to operation 706 to adjust one or more time filters applied to the data samples, according to one embodiment. If the process determines that it may not be advantageous to alter the time filters placed on the data sample set, operation 731 proceeds to operation 707, according to one embodiment.

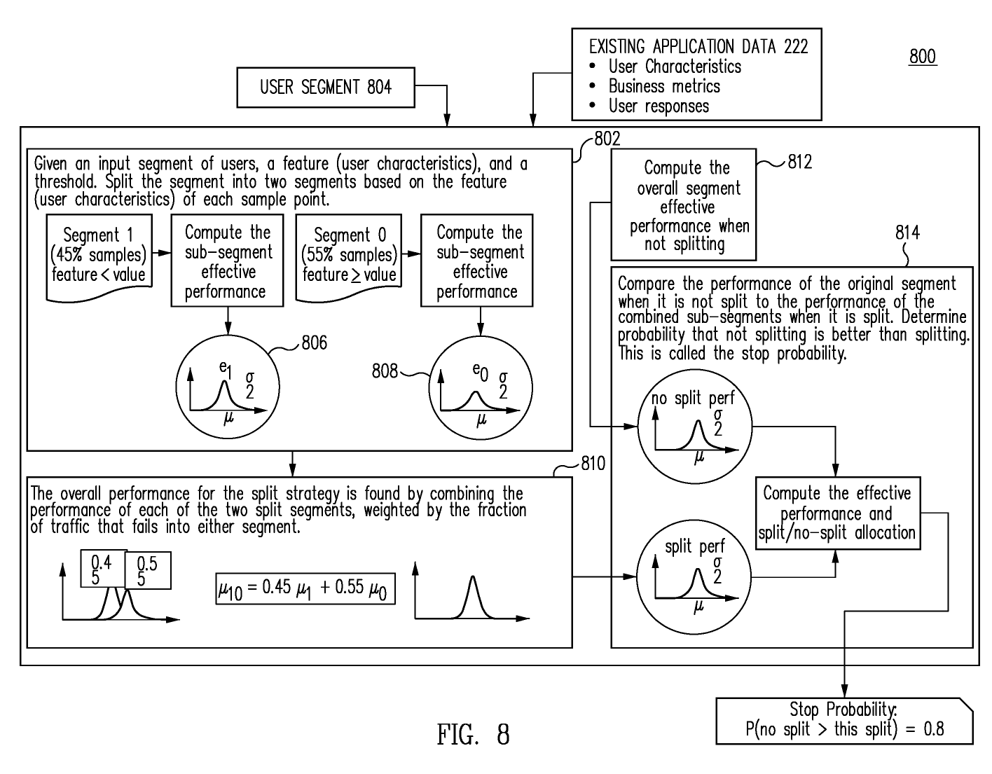

FIG. 8 illustrates an example of a flow diagram for a process 800 for determining a stop probability, according to one embodiment. The process 800 is an example of one technique for determining a stop probability that can be performed during operation 714 of FIG. 7 of the process 700 for defining a user experience analytics model, according to one embodiment.

At block 802, the process splits a user segment 804 into two sub-segments, and determines the effective performance of each sub-segment based on existing software system data 422, according to one embodiment. The existing software system data includes, but is not limited to, user characteristics data, user responses, conversion rates of users to paying customers, revenue generated by the software system, and the like, according to one embodiment. The sub-segments are split based on a value of the threshold and based on whether a user characteristic is less than the value or greater than or equal to the value of the threshold, according to one embodiment. The result of determining the effective performance of each sub-segment is a probabilistic distribution 806 and a probabilistic distribution 808 for the sub-segments, according to one embodiment. The probabilistic distributions 806 and 808 are not just an estimate of the performance of a user experience option on each sub-segment, instead, the probabilistic distributions 806 and 808 are estimations of the probability of the performance of a user experience option on the sub-segments. The effective performances result in probabilistic distributions because the effective performances are estimates of performance that include the uncertainty around how a user will respond to a user experience option integrated into the user's personalized user experience, according to one embodiment. The process proceeds from block 802 to block 810, according to one embodiment.

At block 810, the process determines/computes the combined effective performance of the effective performance of the two sub-segments, according to one embodiment. The process determines the combined effective performance by using addition or other mathematical operations to combine the performance of each sub-segment, with each sub-segment effective performance weighted by the edge frequency (γ) (fraction of parent node traffic from FIG. 6), to remove bias, in one embodiment. The process proceeds from block 810 to block 814, according to one embodiment.

At block 812, the process determines/computes the effective performance of the segment as though the sub-segments were not being split from the segment, according to one embodiment. In other words, the process computes the overall segment effective performance assuming the segment is not being split. The process proceeds from block 812 to block 814, according to one embodiment.

At block 814, the process compares the effective performance of the segment, when it is not split, to the combined effective performance of the sub-sections, to determine the stop probability, according to one embodiment. The stop probability is the probability that the effective performance of the un-split segment is greater or better than the effective performance of splitting the segment, according to one embodiment.

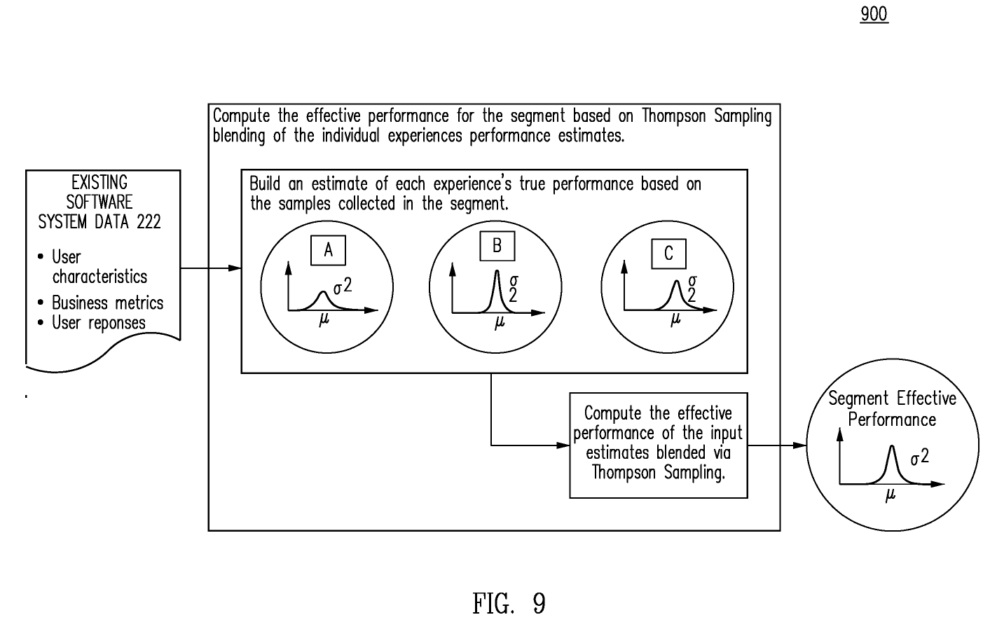

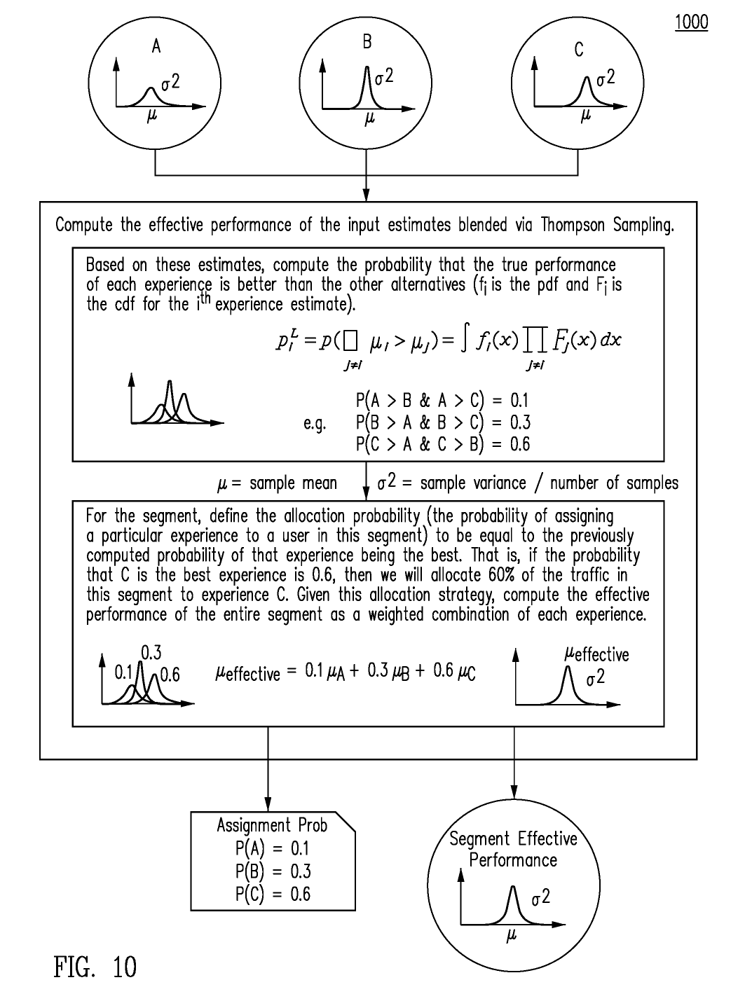

FIG. 9 illustrates an example of a flow diagram of a process 900 for computing the effective performance of a segment or sub-segment of users, according to one embodiment. The process 900 is an example of one technique that can be used by operation 712 (shown in FIG. 7) for the process 700 for defining a user experience analytics model, according to one embodiment. The process 900 is an example of one technique that can be used in blocks 802 and/or 812 (shown in FIG. 8) for the process 800 for determining a stop probability, according to one embodiment.

The process 900 uses existing software system data 422 to compute the effective performance for a segment based on Thompson Sampling blending of the performance of individual user experience options and/or based on each individual user's experience/feedback with the software system (e.g., in response to receiving the user experience option in the user's personalized user experience), according to one embodiment.

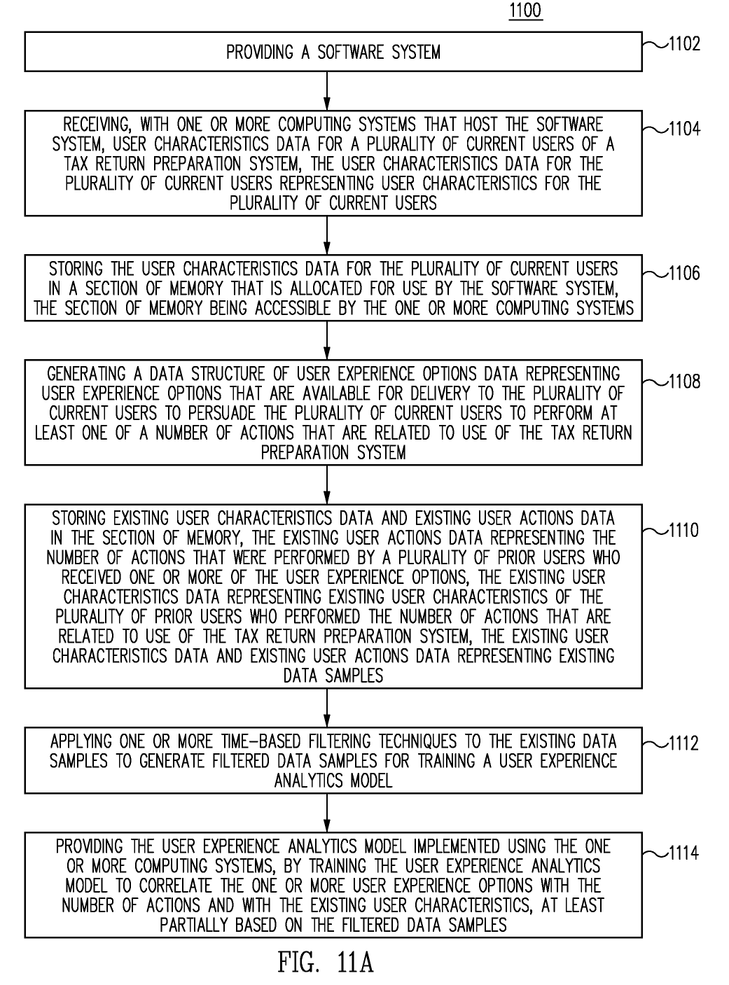

FIG. 10 illustrates an example flow diagram for a process 1000 for computing the effective performance of input estimates blended by Thompson Sampling, according to one embodiment. The process 1000 is an example of one technique that can be used in block 814 (show in FIG. 8) of the process 800 for determining a stop probability, according to one embodiment. The process 1000 is an example of one technique that can be used during the process 700 for computing the effective performance of a segment or sub-segment, according to one embodiment.

The process 1000 uses the probability density function (“PDF”) and the cumulative distribution function (“CDF”) to determine the probability that the true performance of each user's experience or of each user experience option is better than alternative options, according to one embodiment. As illustrated in FIG. 10, the process 1000 computes the effective performance of an entire segment of users as a weighted combination of either each user's experience or of the distribution of a particular user experience option to the users of the segment of users, in one embodiment.

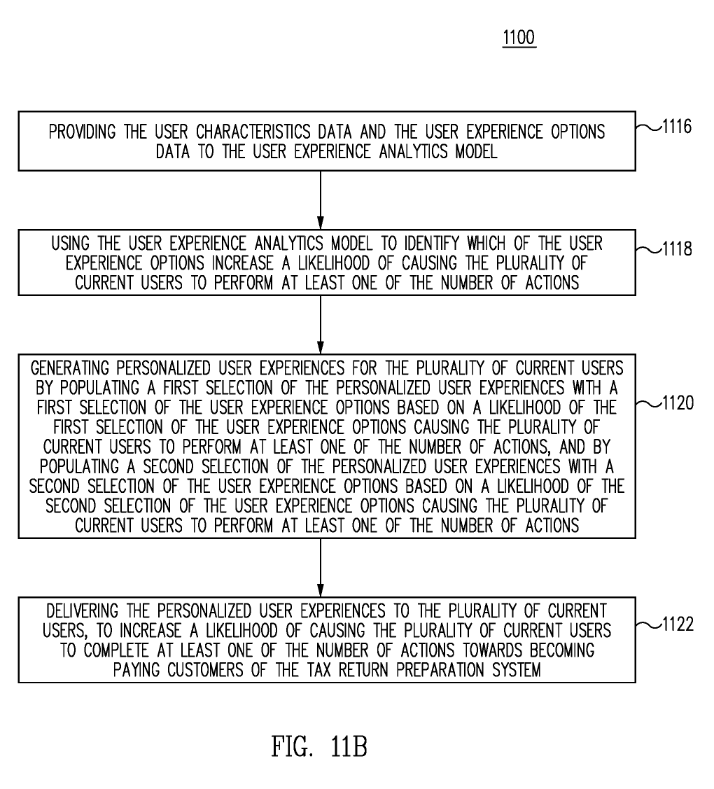

FIGS. 11A and 11B illustrate an example flow diagram of a process 1100 for applying temporal data and/or temporally filtered data to a software system to provide personalized user experiences to users, according to one embodiment.

At operation 1102, the process includes providing a software system, according to one embodiment.

At operation 1104, the process includes receiving, with one or more computing systems that host the software system, user characteristics data for a plurality of current users of a tax return preparation system, the user characteristics data for the plurality of current users representing user characteristics for the plurality of current users, according to one embodiment.

At operation 1106, the process includes storing the user characteristics data for the plurality of current users in a section of memory that is allocated for use by the software system, the section of memory being accessible by the one or more computing systems, according to one embodiment.

At operation 1108, the process includes generating a data structure of user experience options data representing user experience options that are available for delivery to the plurality of current users to persuade the plurality of current users to perform at least one of a number of actions that are related to use of the tax return preparation system, according to one embodiment.

At operation 1110, the process includes storing existing user characteristics data and existing user actions data in the section of memory, the existing user actions data representing the number of actions that were performed by a plurality of prior users who received one or more of the user experience options, the existing user characteristics data representing existing user characteristics of the plurality of prior users who performed the number of actions that are related to use of the tax return preparation system, the existing user characteristics data and existing user actions data representing existing data sample, according to one embodiment.

At operation 1112, the process includes applying one or more time-based filtering techniques to the existing data samples to generate filtered data samples for training a user experience analytics model, according to one embodiment.

At operation 1114, the process includes providing the user experience analytics model implemented using the one or more computing systems, by training the user experience analytics model to correlate the one or more user experience options with the number of actions and with the existing user characteristics, at least partially based on the filtered data samples, according to one embodiment.

At operation 1116, the process includes providing the user characteristics data and the user experience options data to the user experience analytics model, according to one embodiment.

At operation 1118, the process includes using the user experience analytics model to identify which of the user experience options increase a likelihood of causing the plurality of current to perform at least one of the number of actions, according to one embodiment.

At operation 1120, the process includes generating personalized user experiences for the plurality of current users by populating a first selection of the personalized user experiences with a first selection of the user experience options based on a likelihood of the first selection of the user experience options causing the plurality of current users to perform at least one of the number of actions, and by populating a second selection of the personalized user experiences with a second selection of the user experience options based on a likelihood of the second selection of the user experience options causing the plurality of current users to perform at least one of the number of actions, according to one embodiment. Populating the first and second selections of the personalized user experiences with the first and second selections of the user experience options enables the software system to concurrently validate and test effects, on the plurality of current users, of the first selection of the user experience options and the second selection of the user experience options, according to one embodiment.

At operation 1122, the process includes delivering the personalized user experiences to the plurality of current users, to increase a likelihood of causing the plurality of current users to complete at least one of the number of actions towards becoming paying customers of the tax return preparation system, according to one embodiment.

By applying temporal data and/or temporal settings to analytics models to optimize, improve, and/or modify personalized user experiences provided by software systems, implementation of embodiments of the present disclosure allows for significant improvement to the fields of user experience, electronic tax return preparation, data analytics, data collection, and data processing, according to one embodiment. As one illustrative example, by adaptively distributing user experience options to users based on temporal user data and/or temporal settings (e.g., time-based filters), embodiments of the present disclosure allows for progressing a user through software system user flows and/or tax return preparation sessions with fewer processing cycles and less communications bandwidth because the user is more likely to be satisfied and less likely to prematurely terminate his/her user session prior to completing a particular activity (e.g., filing a tax return). This reduces processing cycles and communications bandwidth because a satisfied user does not redundantly use processing cycles and bandwidth to reenter his/her information into competing tax return preparation system and/or software system. In other words, improving customer satisfaction, by personalizing the user experiences, reduces global energy consumption by reducing redundant efforts and inefficiencies associated therewith. As a result, embodiments of the present disclosure allow for improved processor performance, more efficient use of memory access and data storage capabilities, reduced communication channel bandwidth utilization, and therefore faster communications connections.

In addition to improving overall computing performance, by applying temporal data and/or temporal settings to analytics models to optimize, improve, and/or modify personalized user experiences provided by software systems, implementation of embodiments of the present disclosure represent a significant improvement to the field of automated user experiences and, in particular, efficient use of human and non-human resources. As one illustrative example, by increasing personal preferences for user experience options and by reducing presentation of non-preferred/less-effective user experience options, the user can more easily comprehend and interact with digital user experience displays and computing environments, reducing the overall time invested by the user to the tax return preparation or other software system-related tasks. Additionally, selectively presenting user experience options to users, based on their user characteristics, improves and/or increases the likelihood that a potential customer will be converted into a paying customer because the potential customer receives confirmation that the software system appears to understand the particular user's needs and preferences, according to one embodiment. Consequently, using embodiments of the present disclosure, the user experience is less burdensome, less time consuming and allows the user to dedicate more of his or her time to other activities or endeavors, while having confidence that the tax return preparation system and/or software system is adequately addressing the needs of the user.

In accordance with an embodiment, a computer system implemented method applies temporal data and/or temporally filtered data to a software system to provide personalized user experiences to users. The method includes providing a software system, according to one embodiment. The method includes receiving, with one or more computing systems that host the software system, user characteristics data for a plurality of current users of a tax return preparation system, the user characteristics data for the plurality of current users representing user characteristics for the plurality of current users, according to one embodiment. The method includes storing the user characteristics data for the plurality of current users in a section of memory that is allocated for use by the software system, the section of memory being accessible by the one or more computing systems, according to one embodiment. The method includes generating a data structure of user experience options data representing user experience options that are available for delivery to the plurality of current users to persuade the plurality of current users to perform at least one of a number of actions that are related to use of the tax return preparation system, according to one embodiment. The method includes storing existing user characteristics data and existing user actions data in the section of memory, the existing user actions data representing the number of actions that were performed by a plurality of prior users who received one or more of the user experience options, the existing user characteristics data representing existing user characteristics of the plurality of prior users who performed the number of actions that are related to use of the tax return preparation system, the existing user characteristics data and existing user actions data representing existing data samples, according to one embodiment. The method includes applying one or more time-based filtering techniques to the existing data samples to generate filtered data samples for training a user experience analytics model, according to one embodiment. The method includes providing the user experience analytics model implemented using the one or more computing systems, by training the user experience analytics model to correlate the one or more user experience options with the number of actions and with the existing user characteristics, at least partially based on the filtered data samples, according to one embodiment. The method includes providing the user characteristics data and the user experience options data to the user experience analytics model, according to one embodiment. The method includes using the user experience analytics model to identify which of the user experience options increase a likelihood of causing the plurality of current to perform at least one of the number of actions, according to one embodiment. The method includes generating personalized user experiences for the plurality of current users by populating a first selection of the personalized user experiences with a first selection of the user experience options based on a likelihood of the first selection of the user experience options causing the plurality of current users to perform at least one of the number of actions, and by populating a second selection of the personalized user experiences with a second selection of the user experience options based on a likelihood of the second selection of the user experience options causing the plurality of current users to perform at least one of the number of actions, according to one embodiment. Populating the first and second selections of the personalized user experiences with the first and second selections of the user experience options enables the software system to concurrently validate and test effects, on the plurality of current users, of the first selection of the user experience options and the second selection of the user experience options, according to one embodiment. The method includes delivering the personalized user experiences to the plurality of current users, to increase a likelihood of causing the plurality of current users to complete at least one of the number of actions towards becoming paying customers of the tax return preparation system.

In accordance with an embodiment, a computer system implemented method applies temporal data and/or temporally filtered data to a software system to provide personalized user experiences to users of a tax return preparation system. The method includes providing a software system, according to one embodiment. The method includes receiving, with one or more computing systems that host the software system, user characteristics data for a plurality of current users of a tax return preparation system, the user characteristics data for the plurality of current users representing user characteristics for the plurality of current users, according to one embodiment. The method includes storing the user characteristics data for the plurality of current users in a section of memory that is allocated for use by the software system, the section of memory being accessible by the one or more computing systems, according to one embodiment. The method includes generating a data structure of user experience options data representing user experience options that are available for delivery to the plurality of current users to encourage the plurality of current users to perform at least one of a number of actions associated with the tax return preparation system, according to one embodiment. The method includes storing existing user characteristics data and existing user actions data in the section of memory, the existing user actions data representing the number of actions that were performed by a plurality of prior users of the tax return preparation system who received one or more of the user experience options, the existing user characteristics data representing existing user characteristics of the plurality of prior users who performed the number of actions, according to one embodiment. The method includes applying one or more time-based filtering techniques to reduce the existing user characteristics data and the existing user actions data to filtered data samples for use in training a user experience analytics model, according to one embodiment. The method includes training the user experience analytics model to identify preferences of the plurality of current users for the user experience options, according to one embodiment. Training the user experience analytics model includes, with the filtered data samples, defining segments of users that are sub-groups of the plurality of prior users who commonly share one or more existing user characteristics, according to one embodiment. Training the user experience analytics model includes, with the filtered data samples, determining levels of performance for the user experience options among the segments of users, wherein the levels of performance for the user experience options indicate likelihoods of the segments of users to perform one or more of the number of actions in response to receipt of one or more of the user experience options, according to one embodiment. The method includes applying the user characteristics data to the user experience analytics model to associate each of the plurality of current users with at least one of the segments of users, based on similarities between the user characteristics data and the existing user characteristics data, according to one embodiment. The method includes delivering at least two of the user experiences options to at least two subsets of each of the segments of users, to provide at least two different personalized user experiences to the plurality of current users of each of the segments of users, according to one embodiment. The method includes updating the user experience analytics model, at least partially based on ones of the number of actions performed by the plurality of current users of each of the segments of users in response to receiving the user experience options, to identify a more effective one of the at least two personalized user experiences to increase the likelihoods of the segments of users to perform the number of actions, according to one embodiment.

In accordance with one embodiment, a non-transitory computer-readable medium, has instructions which, when executed by one or more processors, performs a method for applying temporal data and/or temporally filtered data to a software system to provide personalized user experiences to users. The method includes providing a software system, according to one embodiment. The method includes receiving, with one or more computing systems that host the software system, user characteristics data for a plurality of current users of a tax return preparation system, the user characteristics data for the plurality of current users representing user characteristics for the plurality of current users, according to one embodiment. The method includes storing the user characteristics data for the plurality of current users in a section of memory that is allocated for use by the software system, the section of memory being accessible by the one or more computing systems, according to one embodiment. The method includes generating a data structure of user experience options data representing user experience options that are available for delivery to the plurality of current users to persuade the plurality of current users to perform at least one of a number of actions that are related to use of the tax return preparation system, according to one embodiment. The method includes storing existing user characteristics data and existing user actions data in the section of memory, the existing user actions data representing the number of actions that were performed by a plurality of prior users who received one or more of the user experience options, the existing user characteristics data representing existing user characteristics of the plurality of prior users who performed the number of actions that are related to use of the tax return preparation system, the existing user characteristics data and existing user actions data representing existing data samples, according to one embodiment. The method includes applying one or more time-based filtering techniques to the existing data samples to generate filtered data samples for training a user experience analytics model, according to one embodiment. The method includes providing the user experience analytics model implemented using the one or more computing systems, by training the user experience analytics model to correlate the one or more user experience options with the number of actions and with the existing user characteristics, at least partially based on the filtered data samples, according to one embodiment. The method includes providing the user characteristics data and the user experience options data to the user experience analytics model, according to one embodiment. The method includes using the user experience analytics model to identify which of the user experience options increase a likelihood of causing the plurality of current to perform at least one of the number of actions, according to one embodiment. The method includes generating personalized user experiences for the plurality of current users by populating a first selection of the personalized user experiences with a first selection of the user experience options based on a likelihood of the first selection of the user experience options causing the plurality of current users to perform at least one of the number of actions, and by populating a second selection of the personalized user experiences with a second selection of the user experience options based on a likelihood of the second selection of the user experience options causing the plurality of current users to perform at least one of the number of actions, according to one embodiment. Populating the first and second selections of the personalized user experiences with the first and second selections of the user experience options enables the software system to concurrently validate and test effects, on the plurality of current users, of the first selection of the user experience options and the second selection of the user experience options, according to one embodiment. The method includes delivering the personalized user experiences to the plurality of current users, to increase a likelihood of causing the plurality of current users to complete at least one of the number of actions towards becoming paying customers of the tax return preparation system.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating,” “accessing,” “adding,” “aggregating,” “alerting,” “applying,” “analyzing,” “associating,” “calculating,” “capturing,” “categorizing,” “classifying,” “comparing,” “creating,” “defining,” “detecting,” “determining,” “distributing,” “eliminating,” “encrypting,” “extracting,” “filtering,” “forwarding,” “generating,” “identifying,” “implementing,” “informing,” “monitoring,” “obtaining,” “posting,” “processing,” “providing,” “receiving,” “requesting,” “saving,” “sending,” “storing,” “substituting,” “transferring,” “transforming,” “transmitting,” “using,” etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGs., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

1. A computer system implemented method for applying temporal data and/or temporally filtered data to a software system to provide personalized user experiences to users, comprising:
providing a software system;
receiving, with one or more computing systems that host the software system, user characteristics data for a plurality of current users of a tax return preparation system, the user characteristics data for the plurality of current users representing user characteristics for the plurality of current users;
storing the user characteristics data for the plurality of current users in a section of memory that is allocated for use by the software system, the section of memory being accessible by the one or more computing systems;
generating a data structure of user experience options data representing user experience options that are available for delivery to the plurality of current users to persuade the plurality of current users to perform at least one of a number of actions that are related to use of the tax return preparation system;
storing existing user characteristics data and existing user actions data in the section of memory, the existing user actions data representing the number of actions that were performed by a plurality of prior users who received one or more of the user experience options, the existing user characteristics data representing existing user characteristics of the plurality of prior users who performed the number of actions that are related to use of the tax return preparation system, the existing user characteristics data and existing user actions data representing existing data samples;
applying one or more time-based filtering techniques to the existing data samples to generate filtered data samples for training a user experience analytics model;
providing the user experience analytics model implemented using the one or more computing systems, by training the user experience analytics model to correlate the one or more user experience options with the number of actions and with the existing user characteristics, at least partially based on the filtered data samples;
providing the user characteristics data and the user experience options data to the user experience analytics model;
using the user experience analytics model to identify which of the user experience options increase a likelihood of causing the plurality of current users to perform at least one of the number of actions; and
generating personalized user experiences for the plurality of current users by populating a first selection of the personalized user experiences with a first selection of the user experience options based on a likelihood of the first selection of the user experience options causing the plurality of current users to perform at least one of the number of actions, and by populating a second selection of the personalized user experiences with a second selection of the user experience options based on a likelihood of the second selection of the user experience options causing the plurality of current users to perform at least one of the number of actions,
wherein populating the first and second selections of the personalized user experiences with the first and second selections of the user experience options enables the software system to concurrently validate and test effects, on the plurality of current users, of the first selection of the user experience options and the second selection of the user experience options; and
delivering the personalized user experiences to the plurality of current users, to increase a likelihood of causing the plurality of current users to complete at least one of the number of actions towards becoming paying customers of the tax return preparation system.

2. The computer system implemented method of claim 1, wherein the user characteristics data and the existing user characteristics data include time data.

3. The computer system implemented method of claim 2, wherein the time data are selected from a group of time data consisting of:
data indicating how many different user interface display pages are visited;
data indicating how long users remain logged into the tax return preparation system;
data indicating how many times users log into the tax return preparation system;
data indicating how much time passes between successive logins into the tax return preparation system;
data indicating how much time passes between first and last login into the tax return preparation system;
data indicating time-of-day interactions with the tax return preparation system;
data indicating day-of-week interactions with the tax return preparation system;
data indicating time-of-month interactions with the tax return preparation system; and
data indicating time-of-year interactions with the tax return preparation system.

4. The computer system implemented method of claim 3, wherein interactions with the tax return preparation system include viewing, logging into, and using the tax return preparation system.

5. The computer system implemented method of claim 1, wherein applying one or more time-based filtering techniques, includes modifying the one or more time-based filtering techniques applied to the existing data samples to adjust one or more characteristics of the user experience analytics model.

6. The computer system implemented method of claim 5, wherein the one or more characteristics of the user experience analytics model are selected from a group of characteristics consisting of:
a level of variance;
a level of sensitivity to changes in existing data samples;
a level of uncertainty; and
a level of performance.

7. The computer system implemented method of claim 1, wherein applying one or more time-based filtering techniques includes sizing a time-based width of the one or more time-based filtering techniques to adjust one or more characteristics of the user experience analytics model.

8. The computer system implemented method of claim 1, wherein the one or more time-based filtering techniques are selected from a group of time filtering techniques consisting of:
a sliding window; and
a decaying window.

9. The computer system implemented method of claim 8, wherein the decaying window adjusts weights of the existing data samples in accordance with a function that is selected from a group of functions consisting of:
a step function;
a linear function;
an exponential function;
a logarithmic function;
a tangent function;
a cube root function; and
a cubic function.

10. The computer system implemented method of claim 1, wherein the software system includes the tax return preparation system.

11. The computer system implemented method of claim 1, wherein the user experience analytics model includes a hierarchical decision tree, the hierarchical decision tree having a plurality of nodes, each node being associated with one of a plurality of segments of users and being associated with distribution frequency rates for applying one or more of the user experience options to the plurality of segments of users.

12. The computer system implemented method of claim 11, wherein the distribution frequency rates are probabilities with which at least two different ones of the user experience options are provided to at least two subsets of the plurality of current users who are in a same one of the plurality of segments of users.

13. The computer system implemented method of claim 1, wherein populating the user experiences for the plurality of current users based on the likelihood of the first selection and based on the likelihood of the second selection is an implementation of dynamic A/B testing of the user experience options.

14. The computer system implemented method of claim 1, wherein the user characteristics data and the existing user characteristics data are selected from a group of user characteristics data consisting of:
data indicating user computing system characteristics;
data indicating time-related information;
data indicating geographical information;
data indicating external and independent marketing segments;
data identifying an external referrer of the user;
data indicating a number of visits made to a service provider website;
data indicating an age of the user;
data indicating an age of a spouse of the user;
data indicating a zip code;
data indicating a tax return filing status;
data indicating state income;
data indicating a home ownership status;
data indicating a home rental status;
data indicating a retirement status;
data indicating a student status;
data indicating an occupation of the user;
data indicating an occupation of a spouse of the user;
data indicating whether the user is claimed as a dependent;
data indicating whether a spouse of the user is claimed as a dependent;
data indicating whether another taxpayer is capable of claiming the user as a dependent;
data indicating whether a spouse of the user is capable of being claimed as a dependent;
data indicating salary and wages;
data indicating taxable interest income;
data indicating ordinary dividend income;
data indicating qualified dividend income;
data indicating business income;
data indicating farm income;
data indicating capital gains income;
data indicating taxable pension income;
data indicating pension income amount;
data indicating IRA distributions;
data indicating unemployment compensation;
data indicating taxable IRA;
data indicating taxable Social Security income;
data indicating amount of Social Security income;
data indicating amount of local state taxes paid;
data indicating whether the user filed a previous years' federal itemized deduction;
data indicating whether the user filed a previous years' state itemized deduction;
data indicating whether the user is a returning user to a tax return preparation system;
data indicating an annual income;
data indicating an employer's address;
data indicating contractor income;
data indicating a marital status;
data indicating a medical history;
data indicating dependents;
data indicating assets;
data indicating spousal information;
data indicating children's information;
data indicating an address;
data indicating a name;
data indicating a Social Security Number;
data indicating a government identification;
data indicating a date of birth;
data indicating educator expenses;
data indicating health savings account deductions;
data indicating moving expenses;
data indicating IRA deductions;
data indicating student loan interest deductions;
data indicating tuition and fees;
data indicating medical and dental expenses;
data indicating state and local taxes;
data indicating real estate taxes;
data indicating personal property tax;
data indicating mortgage interest;
data indicating charitable contributions;
data indicating casualty and theft losses;
data indicating unreimbursed employee expenses;
data indicating an alternative minimum tax;
data indicating a foreign tax credit;
data indicating education tax credits;
data indicating retirement savings contributions; and
data indicating child tax credits.

15. The computer system implemented method of claim 1, wherein the number of actions are selected from a group of number actions consisting of:
providing additional personal information to at least one of the tax return preparation system and the software system;
completing a sequence of questions;
purchasing a service;
selecting a user interface element;
providing feedback;
referring a colleague to user the tax return preparation system;
filing a tax return with the tax return preparation system; and
using the tax return preparation system for at least a predetermined period of time.

16. A computer system implemented method for applying temporal data and/or temporally filtered data to a software system to provide personalized user experiences to users of a tax return preparation system, comprising:
providing a software system;
receiving, with one or more computing systems that host the software system, user characteristics data for a plurality of current users of a tax return preparation system, the user characteristics data for the plurality of current users representing user characteristics for the plurality of current users;
storing the user characteristics data for the plurality of current users in a section of memory that is allocated for use by the software system, the section of memory being accessible by the one or more computing systems;
generating a data structure of user experience options data representing user experience options that are available for delivery to the plurality of current users to encourage the plurality of current users to perform at least one of a number of actions associated with the tax return preparation system;
storing existing user characteristics data and existing user actions data in the section of memory, the existing user actions data representing the number of actions that were performed by a plurality of prior users of the tax return preparation system who received one or more of the user experience options, the existing user characteristics data representing existing user characteristics of the plurality of prior users who performed the number of actions;
applying one or more time-based filtering techniques to reduce the existing user characteristics data and the existing user actions data to filtered data samples for use in training a user experience analytics model;
training the user experience analytics model to identify preferences of the plurality of current users for the user experience options, wherein training the user experience analytics model includes:
with the filtered data samples, defining segments of users that are sub-groups of the plurality of prior users who commonly share one or more existing user characteristics; and
with the filtered data samples, determining levels of performance for the user experience options among the segments of users, wherein the levels of performance for the user experience options indicate likelihoods of the segments of users to perform one or more of the number of actions in response to receipt of one or more of the user experience options;
applying the user characteristics data to the user experience analytics model to associate each of the plurality of current users with at least one of the segments of users, based on similarities between the user characteristics data and the existing user characteristics data;
delivering at least two of the user experiences options to at least two subsets of each of the segments of users, to provide at least two different personalized user experiences to the plurality of current users of each of the segments of users; and
updating the user experience analytics model, at least partially based on ones of the number of actions performed by the plurality of current users of each of the segments of users in response to receiving the user experience options, to identify a more effective one of the at least two personalized user experiences to increase the likelihoods of the segments of users to perform the number of actions.

17. The computer system implemented method of claim 16, wherein the user characteristics data and the existing user characteristics data include time data.

18. The computer system implemented method of claim 17, wherein the time data are selected from a group of time data consisting of:
data indicating how many different user interface display pages are visited;
data indicating how long users remain logged into the tax return preparation system;
data indicating how many times users log into the tax return preparation system;
data indicating how much time passes between successive logins into the tax return preparation system;
data indicating how much time passes between first and last login into the tax return preparation system;
data indicating time-of-day interactions with the tax return preparation system;
data indicating day-of-week interactions with the tax return preparation system;
data indicating time-of-month interactions with the tax return preparation system; and
data indicating time-of-year interactions with the tax return preparation system.

19. The computer system implemented method of claim 16, wherein applying one or more time-based filtering techniques, includes modifying the one or more time-based filtering techniques to adjust one or more characteristics of the user experience analytics model.

20. The computer system implemented method of claim 19, wherein the one or more characteristics of the user experience analytics model are selected from a group of characteristics consisting of:
a level of variance;
a level of sensitivity to changes in existing data samples;
a level of uncertainty; and
a level of performance.

21. The computer system implemented method of claim 16, wherein applying one or more time-based filtering techniques includes sizing a time-based width of the one or more time-based filtering techniques to adjust one or more characteristics of the user experience analytics model.

22. The computer system implemented method of claim 16, wherein the one or more time-based filtering techniques are selected from a group of time filtering techniques consisting of:
a sliding window; and
a decaying window.

23. The computer system implemented method of claim 22, wherein the decaying window adjusts weights of the filtered data samples in accordance with a function that is selected from a group of functions consisting of:
a step function;
a linear function;
an exponential function;
a logarithmic function;
a tangent function;
a cube root function; and
a cubic function.

24. The computer system implemented method of claim 16, wherein the software system includes the tax return preparation system.

25. The computer system implemented method of claim 16, wherein the user experience analytics model includes a hierarchical decision tree, the hierarchical decision tree having a plurality of nodes, each node being associated with one of a plurality of segments of users and being associated with distribution frequency rates for applying one or more of the user experience options to the plurality of segments of users.

26. The computer system implemented method of claim 16, wherein the number of actions are selected from a group of number actions consisting of:
providing additional personal information to at least one of the tax return preparation system and the software system;
completing a sequence of questions;
purchasing a service;
selecting a user interface element;
providing feedback;
referring a colleague to user the tax return preparation system;
filing a tax return with the tax return preparation system; and
using the tax return preparation system for at least a predetermined period of time.

27. A non-transitory computer-readable medium, having instructions which, when executed by one or more processors, performs a method for applying temporal data and/or temporally filtered data to a software system to provide personalized user experiences to users, comprising:
providing a software system;
receiving, with one or more computing systems that host the software system, user characteristics data for a plurality of current users of a tax return preparation system, the user characteristics data for the plurality of current users representing user characteristics for the plurality of current users;
storing the user characteristics data for the plurality of current users in a section of memory that is allocated for use by the software system, the section of memory being accessible by the one or more computing systems;
generating a data structure of user experience options data representing user experience options that are available for delivery to the plurality of current users to persuade the plurality of current users to perform at least one of a number of actions that are related to use of the tax return preparation system;
storing existing user characteristics data and existing user actions data in the section of memory, the existing user actions data representing the number of actions that were performed by a plurality of prior users who received one or more of the user experience options, the existing user characteristics data representing existing user characteristics of the plurality of prior users who performed the number of actions that are related to use of the tax return preparation system, the existing user characteristics data and existing user actions data representing existing data samples;
applying one or more time-based filtering techniques to the existing data samples to generate filtered data samples for training a user experience analytics model;
providing the user experience analytics model implemented using the one or more computing systems, by training the user experience analytics model to correlate the one or more user experience options with the number of actions and with the existing user characteristics, at least partially based on the filtered data samples;
providing the user characteristics data and the user experience options data to the user experience analytics model;
using the user experience analytics model to identify which of the user experience options increase a likelihood of causing the plurality of current users to perform at least one of the number of actions; and
generating personalized user experiences for the plurality of current users by populating a first selection of the personalized user experiences with a first selection of the user experience options based on a likelihood of the first selection of the user experience options causing the plurality of current users to perform at least one of the number of actions, and by populating a second selection of the personalized user experiences with a second selection of the user experience options based on a likelihood of the second selection of the user experience options causing the plurality of current users to perform at least one of the number of actions,
wherein populating the first and second selections of the personalized user experiences with the first and second selections of the user experience options enables the software system to concurrently validate and test effects, on the plurality of current users, of the first selection of the user experience options and the second selection of the user experience options; and
delivering the personalized user experiences to the plurality of current users, to increase a likelihood of causing the plurality of current users to complete at least one of the number of actions towards becoming paying customers of the tax return preparation system.

28. The non-transitory computer-readable medium of claim 27, wherein the user characteristics data and the existing user characteristics data include time data.

29. The non-transitory computer-readable medium of claim 28, wherein the time data are selected from a group of time data consisting of:
data indicating how many different user interface display pages are visited;
data indicating how long users remain logged into the tax return preparation system;
data indicating how many times users log into the tax return preparation system;
data indicating how much time passes between successive logins into the tax return preparation system;
data indicating how much time passes between first and last login into the tax return preparation system;
data indicating time-of-day interactions with the tax return preparation system;
data indicating day-of-week interactions with the tax return preparation system;
data indicating time-of-month interactions with the tax return preparation system; and
data indicating time-of-year interactions with the tax return preparation system.

30. The non-transitory computer-readable medium of claim 27, wherein applying one or more time-based filtering techniques, includes modifying the one or more time-based filtering techniques applied to the existing data samples to adjust one or more characteristics of the user experience analytics model.

31. The non-transitory computer-readable medium of claim 30, wherein the one or more characteristics of the user experience analytics model are selected from a group of characteristics consisting of:
a level of variance;
a level of sensitivity to changes in existing data samples;
a level of uncertainty; and
a level of performance.

32. The non-transitory computer-readable medium of claim 27, wherein the one or more time-based filtering techniques are selected from a group of time filtering techniques consisting of:
a sliding window; and
a decaying window.

33. The non-transitory computer-readable medium of claim 32, wherein the decaying window adjusts weights of the existing data samples in accordance with a function that is selected from a group of functions consisting of:
a step function;
a linear function;
an exponential function;
a logarithmic function;
a tangent function;
a cube root function; and
a cubic function.

34. The non-transitory computer-readable medium of claim 27, wherein the software system includes the tax return preparation system.
